(19) United States
(12) Patent Application Publication
(10) Pub. No.: US 2025/0254101 A1
(43) Pub. Date: Aug. 7, 2025

(54) AI TASK INDICATION METHOD, AND COMMUNICATION APPARATUS AND SYSTEM

(71) Applicant: HUAWEI TECHNOLOGIES CO., LTD., Shenzhen (CN)

(72) Inventors: Yunfei Qiao, Hangzhou (CN); Gongzheng Zhang, Hangzhou (CN); Rong Li, Boulogne Billancourt (FR)

(73) Assignee: HUAWEI TECHNOLOGIES CO., LTD., Shenzhen (CN)

(21) Appl. No.: 19/185,066

(22) Filed: Apr. 21, 2025

Related U.S. Application Data
(63) Continuation of application No. PCT/CN2022/126752, filed on Oct. 21, 2022.

(51) Int. Cl. H04L 41/16; H04L 41/085; H04W 8/22

(52) U.S. Cl. CPC H04L 41/16; H04L 41/085; H04W 8/22

(57) ABSTRACT

An AI task indication method, and a communication apparatus and system, and may be applied to a scenario in which AI is combined with a wireless network. The method may include: A control node learns of an AI task and determines orchestration information of at least one network node for the AI task. Orchestration information of each network node may indicate an operation provided when each network node participates in execution of the AI task. The control node sends the orchestration information to some or all of the at least one network node. In this manner, a network node in the wireless network can execute the AI task, to integrate AI and the wireless network. In addition, the control node can perform unified orchestration, to improve global efficiency.

### CROSS-REFERENCE TO RELATED APPLICATIONS

This application is a continuation of International Application No. PCT/CN2022/126752, filed on Oct. 21, 2022, the disclosure of which is hereby incorporated by reference in its entirety.

### TECHNICAL FIELD

This application relates to the field of wireless communication, specifically, to a wireless communication technology to which an intelligent network is applied, and in particular, to an AI task indication method, and a communication apparatus and system.

### BACKGROUND

Artificial intelligence (AI) is being used in many applications and there exists a need to use AI at the wireless network architecture level. There exists a need to integrate AI at the network level to implement network native intelligence and terminal intelligence, to assist or respond to new requirements and new scenarios. How to integrate AI into the wireless network, however, is an urgent problem to be resolved.

### SUMMARY

The present disclosure provides an AI task indication method, and a communication apparatus and system. A control node determines orchestration information for an AI task and indicates the orchestration information, so that a network node in a wireless network can execute the AI task, to integrate AI and the wireless network.

According to a first aspect, an AI task indication method is provided. The method may be performed by a control node. The control node may be a device or may be a chip (or a chip system) or a circuit used for the device. This is not limited in the present disclosure.

The method may include: The control node determines first orchestration information for an AI task. The first orchestration information indicates a first network node to execute a first task of the AI task. The control node sends the first orchestration information to the first network node.

Based on the foregoing technical solution, the control node may determine orchestration information of a network node for the AI task, and send the orchestration information to the network node, so that the network node can perform a corresponding operation based on the orchestration information. In this way, a network node in a wireless network can execute the AI task, to integrate AI and the wireless network. In addition, the control node can perform unified orchestration, to improve global efficiency.

With reference to the first aspect, in some implementations of the first aspect, the method further includes: The control node determines second orchestration information for the AI task. The second orchestration information indicates a second network node to execute a second task of the AI task. The control node sends the second orchestration information to the first network node, or the control node sends the second orchestration information to the second network node.

Based on the foregoing technical solution, the control node determines orchestration information of a plurality of network nodes for the AI task. In this way, global efficiency can be improved. In addition, the control node may send orchestration information of each network node to a network node (for example, the first network node), to reduce signaling overheads caused by sending the orchestration information to each network node by the control node. Alternatively, the control node may send the orchestration information of each network node to each network node. This can reduce signaling overheads caused by transmission of the orchestration information between network nodes.

With reference to the first aspect, in some implementations of the first aspect, the method further includes: The control node determines second orchestration information for the AI task. The second orchestration information indicates a second network node to execute a second task of the AI task. The control node sends the first orchestration information and the second orchestration information to the second network node. That the control node sends the first orchestration information to the first network node includes: The control node sends the first orchestration information and the second orchestration information to the first network node.

Based on the foregoing technical solution, the control node determines orchestration information of a plurality of network nodes for the AI task. In this way, global efficiency can be improved. In addition, the control node may send orchestration information of all network nodes to each network node. This can reduce overheads caused by selecting the orchestration information of each network node by the control node.

With reference to the first aspect, in some implementations of the first aspect, the first network node is the 1st network node participating in execution of the AI task.

With reference to the first aspect, in some implementations of the first aspect, the first orchestration information includes at least one piece of the following information: the first task, an identifier of the first network node, a resource provided for executing the first task by the first network node, or an exit condition of executing the first task by the first network node.

With reference to the first aspect, in some implementations of the first aspect, that the control node determines first orchestration information for an AI task includes: The control node determines the first orchestration information for the AI task based on an AI capability of the first network node.

Based on the foregoing technical solution, the control node may determine orchestration information of a network node based on an AI capability of the network node. In this way, the orchestration information determined by the control node may match an AI capability of each network node, to reduce a probability that the network node cannot execute the AI task.

With reference to the first aspect, in some implementations of the first aspect, the method further includes: The control node receives response information from the first network node. The response information indicates whether the first network node agrees with the first orchestration information.

Based on the foregoing technical solution, the network node may further send, to the control node, a response indicating whether the network node agrees with the orchestration information. In this way, the control node can learn of whether the network node agrees with the orchestration information, and then determine whether to deliver the AI task.

According to a second aspect, an AI task indication method is provided. The method may be performed by a network node. The network node may be a device or may be a chip (or a chip system) or a circuit used for the device. This is not limited in the present disclosure. The following uses a first network node as an example for description.

The method may include: The first network node receives first orchestration information from a control node. The first orchestration information indicates the first network node to execute a first task of an AI task. The first network node executes the first task based on the first orchestration information.

With reference to the second aspect, in some implementations of the second aspect, that the first network node receives first orchestration information from a control node includes: The first network node receives the first orchestration information and second orchestration information from the control node. The second orchestration information indicates a second network node to execute a second task of the AI task. The method further includes: The first network node sends the second orchestration information to the second network node.

With reference to the second aspect, in some implementations of the second aspect, that the first network node sends the second orchestration information to the second network node includes: The first network node sends a processing result of the first task and the second orchestration information to the second network node.

With reference to the second aspect, in some implementations of the second aspect, the first network node is the 1st network node participating in execution of the AI task.

With reference to the second aspect, in some implementations of the second aspect, the first orchestration information includes at least one piece of the following information: the first task, an identifier of the first network node, a resource provided for executing the first task by the first network node, or an exit condition of executing the first task by the first network node.

With reference to the second aspect, in some implementations of the second aspect, the method further includes: The first network node sends an AI capability of the first network node to the control node.

With reference to the second aspect, in some implementations of the second aspect, the method further includes: The first network node sends response information to the control node. The response information indicates whether the first network node agrees with the first orchestration information.

With reference to the second aspect, in some implementations of the second aspect, the method further includes: The first network node sends the first task or a part of the first task to at least one terminal apparatus; or the first network node sends the first task or a part of the first task to the second network node. The second network node is at least one network node participating in execution of the AI task.

Based on the foregoing technical solution, the network node may schedule another network node (for example, the second network node) or the terminal apparatus to cooperatively execute the AI task. In this way, the AI task can be executed by using idle computing power, so that resource utilization can be improved, and flexibility can also be improved.

With reference to the second aspect, in some implementations of the second aspect, the at least one terminal apparatus is in a preset state.

Based on the foregoing technical solution, different states are defined for a terminal, so that the network node can learn, based on a state of the terminal, of whether the terminal can participate in execution of the AI task. For example, the network node may send the AI task to a terminal in the preset state. In other words, the terminal in the preset state may participate in execution of the AI task.

With reference to the second aspect, in some implementations of the second aspect, before the first network node sends the first task or the part of the first task to the at least one terminal apparatus, the method further includes: The first network node sends notification information to the at least one terminal apparatus. The notification information indicates to adjust the at least one terminal apparatus to the preset state.

For beneficial effects of the second aspect and all possible designs, refer to the related descriptions of the first aspect. Details are not described herein again.

According to a third aspect, an AI task indication method is provided. The method may be performed by a network node. The network node may be a device, or may be a chip (or a chip system) or a circuit used for the device. This is not limited in the present disclosure. The following uses a first network node as an example for description.

The method may include: The first network node sends a processing result of a first task of an AI task and target state information to a second network node. The target state information indicates a target result of the AI task.

For example, the processing result of the first task and the target state information may implicitly indicate the second network node to participate in execution of the AI task. For example, the second network node executes a second task of the AI task.

Based on the foregoing technical solution, network nodes may cooperatively execute the AI task, and the network node may determine, based on a current processing result and the target state information, whether to participate in execution of the AI task, to reduce signaling overheads caused by indicating the network node to participate in execution of the AI task.

With reference to the third aspect, in some implementations of the third aspect, that the first network node sends a processing result of a first task of an AI task and target state information to a second network node includes: The first network node sends the processing result of the first task of the AI task and the target state information to the second network node based on an AI capability of the second network node.

Based on the foregoing technical solution, the first network node may determine, based on the AI capability of the second network node, whether to send the processing result of the first task of the AI task and the target state information to the second network node, that is, determine whether the second network node participates in execution of the AI task. In this way, a probability that the second network node cannot participate in execution of the AI task can be reduced.

With reference to the third aspect, in some implementations of the third aspect, the method further includes: The first network node sends first request information to a control node or the second network node. The first request information requests the AI capability of the second network node. The first network node receives response information of the first request information. The response information of the first request information indicates the AI capability of the second network node.

With reference to the third aspect, in some implementations of the third aspect, before the first network node sends the processing result of the first task of the AI task and the target state information to the second network node, the method further includes: The first network node sends second request information to the second network node. The second request information requests the second network node to cooperatively execute the AI task.

Based on the foregoing technical solution, when the first network node determines that the second network node agrees to cooperatively execute the AI task, the first network node sends the processing result of the first task of the AI task and the target state information to the second network node, to reduce a probability that the second network node cannot participate in execution of the AI task.

With reference to the third aspect, in some implementations of the third aspect, the processing result of the first task indicates current state information of the AI task.

Based on the foregoing technical solution, the current state information of the AI task and the target state information may indicate the second network node to participate in execution of the AI task, for example, to execute the second task of the AI task.

With reference to the third aspect, in some implementations of the third aspect, the method further includes: The first network node further sends area information to the second network node. The area information is used by the second network node to determine a network node that cooperatively executes the AI task.

With reference to the third aspect, in some implementations of the third aspect, the method further includes: The first network node sends the first task or a part of the first task to at least one terminal apparatus.

Based on the foregoing technical solution, the network node may schedule the terminal apparatus to cooperatively execute the AI task. In this way, the AI task can be executed by using idle computing power, so that resource utilization can be improved, and flexibility can also be improved.

With reference to the third aspect, in some implementations of the third aspect, the at least one terminal apparatus is in a preset state.

Based on the foregoing technical solution, different states are defined for a terminal, so that the network node can learn, based on a state of the terminal, of whether the terminal can participate in execution of the AI task. For example, the network node may send the AI task to a terminal in the preset state. In other words, AI in the preset state may participate in execution of the AI task.

With reference to the third aspect, in some implementations of the third aspect, before the first network node sends the first task or the part of the first task to the at least one terminal apparatus, the method further includes: The first network node sends notification information to the at least one terminal apparatus. The notification information indicates to adjust the at least one terminal apparatus to the preset state.

According to a fourth aspect, an AI task indication method is provided. The method may be performed by a network node. The network node may be a device, or may be a chip (or a chip system) or a circuit used for the device. This is not limited in the present disclosure. The following uses a second network node as an example for description.

The method may include: The second network node receives a processing result of a first task of an AI task and target state information from a first network node. The target state information indicates a target result of the AI task. The second network node executes a second task of the AI task based on the processing result of the first task and the target state information.

With reference to the fourth aspect, in some implementations of the fourth aspect, the method further includes: The second network node sends an AI capability of the second network node to a control node or the first network node.

With reference to the fourth aspect, in some implementations of the fourth aspect, before the second network node receives the processing result of the first task of the AI task and the target state information from the first network node, the method further includes: The second network node receives second request information from the first network node. The second request information requests the second network node to cooperatively execute the AI task.

With reference to the fourth aspect, in some implementations of the fourth aspect, the processing result of the first task indicates current state information of the AI task; and that the second network node executes a second task of the AI task based on the processing result of the first task and the target state information includes: The second network node executes the second task of the AI task based on the current state information of the AI task and the target state information.

With reference to the fourth aspect, in some implementations of the fourth aspect, the method further includes: The second network node receives area information from the first network node. The area information is used by the second network node to determine a network node that cooperatively executes the AI task.

With reference to the fourth aspect, in some implementations of the fourth aspect, the method further includes: The second network node sends the second task or a part of the second task to at least one terminal apparatus.

With reference to the fourth aspect, in some implementations of the fourth aspect, the at least one terminal apparatus is in a preset state.

With reference to the fourth aspect, in some implementations of the fourth aspect, before the second network node sends the second task or the part of the second task to the at least one terminal apparatus, the method further includes: The second network node sends notification information to the at least one terminal apparatus. The notification information indicates to adjust the at least one terminal apparatus to the preset state.

For beneficial effects of the fourth aspect and all possible designs, refer to the related descriptions of the third aspect. Details are not described herein again.

According to a fifth aspect, an AI task indication method is provided. The method may be performed by a network node. The network node may be a device, or may be a chip (or a chip system) or a circuit used for the device. This is not limited in the present disclosure.

The method may include: The network node sends an AI task to at least one terminal apparatus. The at least one terminal apparatus is in a preset state.

Based on the foregoing technical solution, different states are defined for a terminal, so that the network node can learn, based on a state of the terminal, of whether the terminal can execute the AI task. For example, the network node may send the AI task to a terminal in the preset state. In other words, AI in the preset state may execute the AI task.

With reference to the fifth aspect, in some implementations of the fifth aspect, before the network node sends the AI task to the at least one terminal apparatus, the method further includes: The network node sends notification information to the at least one terminal apparatus. The notification information indicates to adjust the at least one terminal apparatus to the preset state.

According to a sixth aspect, an AI task indication method is provided. The method may be performed by a terminal apparatus. The terminal apparatus may be a device, or may be a chip (or a chip system) or a circuit used for the device. This is not limited in the present disclosure.

The method may include: The terminal apparatus receives an AI task from a network node. The terminal apparatus is in a preset state. The terminal apparatus executes the AI task.

With reference to the sixth aspect, in some implementations of the sixth aspect, before the terminal apparatus receives the AI task from the network node, the method further includes: The terminal apparatus receives notification information from the network node. The notification information indicates to adjust the terminal apparatus to the preset state.

For beneficial effects of the sixth aspect and all possible designs, refer to the related descriptions of the fifth aspect. Details are not described herein again.

According to a seventh aspect, an AI task indication method is provided. The method may be performed by a communication system. The communication system includes, for example, a control node and a network node. The control node and the network node each may be a device, or may be a chip (or a chip system) or a circuit used for the device. This is not limited in the present disclosure.

The method may include: The control node determines first orchestration information for an AI task. The first orchestration information indicates a first network node to execute a first task of the AI task. The control node sends the first orchestration information to the first network node. The first network node executes the first task based on the first orchestration information.

The control node may be, for example, the control node according to the first aspect, and the first network node may be, for example, the first network node according to the second aspect.

For beneficial effects of the seventh aspect, refer to the related descriptions of the first aspect. Details are not described herein again.

According to an eighth aspect, an AI task indication method is provided. The method may be performed by a communication system. The communication system includes, for example, a first network node and a second network node. The first network node and the second network node each may be a device or may be a chip (or a chip system) or a circuit used for the device. This is not limited in the present disclosure.

The method may include: The first network node sends a processing result of a first task of an AI task and target state information to the second network node. The target state information indicates a target result of the AI task. The second network node executes a second task of the AI task based on the processing result of the first task and the target state information.

The first network node may be, for example, the first network node according to the third aspect, and the second network node may be, for example, the second network node according to the fourth aspect.

For beneficial effects of the eighth aspect, refer to the related descriptions of the third aspect. Details are not described herein again.

According to a ninth aspect, an AI task indication method is provided. The method may be performed by a communication system. The communication system includes, for example, a network node and a terminal apparatus. The network node and the terminal apparatus each may be a device, or may be a chip (or a chip system) or a circuit used for the device. This is not limited in the present disclosure.

The method may include: The network node sends an AI task to at least one terminal apparatus. The at least one terminal apparatus is in a preset state. The at least one terminal apparatus executes the AI task.

The network node may be, for example, the network node according to the fifth aspect, and the terminal apparatus may be, for example, the terminal apparatus according to the sixth aspect.

For beneficial effects of the ninth aspect, refer to the related descriptions of the fifth aspect. Details are not described herein again.

According to a tenth aspect, a communication apparatus is provided. The apparatus is configured to perform the method according to any one of the first aspect to the ninth aspect. Specifically, the apparatus may include a unit and/or a module configured to perform the method according to any implementation of any one of the first aspect to the ninth aspect, for example, a processing unit and/or a communication unit.

In an implementation, the apparatus is a communication device. When the apparatus is a communication device, the communication unit may be a transceiver or an input/output interface, and the processing unit may be at least one processor. Optionally, the transceiver may be a transceiver circuit. Optionally, the input/output interface may be an input/output circuit.

In another implementation, the apparatus is a chip, a chip system, or a circuit used in a communication device. When the apparatus is a chip, a chip system, or a circuit used in a terminal device, the communication unit may be an input/output interface, an interface circuit, an output circuit, an input circuit, a pin, a related circuit, or the like on the chip, the chip system, or the circuit, and the processing unit may be at least one processor, processing circuit, logic circuit, or the like.

According to an eleventh aspect, a communication apparatus is provided. The apparatus includes: a memory, configured to store a program; and at least one processor, configured to execute a computer program or instructions stored in the memory, to perform the method according to any implementation of any one of the first aspect to the ninth aspect.

In an implementation, the apparatus is a communication device.

In another implementation, the apparatus is a chip, a chip system, or a circuit used in a communication device.

According to a twelfth aspect, the present disclosure provides a processor, configured to perform the methods provided in the foregoing aspects.

Operations such as sending and obtaining/receiving related to the processor may be understood as operations such as output and input of the processor, or operations such as sending and receiving performed by a radio frequency circuit and an antenna, unless otherwise specified, or provided that the operations do not contradict actual functions or internal logic of the operations in related descriptions. This is not limited in the present disclosure.

According to a thirteenth aspect, a computer-readable storage medium is provided. The computer-readable medium stores program code to be executed by a device, and the program code includes the method according to any implementation of any one of the first aspect to the ninth aspect.

According to a fourteenth aspect, a computer program product including instructions is provided. When the computer program product runs on a computer, the computer is enabled to perform the method according to any implementation of any one of the first aspect to the ninth aspect.

According to a fifteenth aspect, a chip is provided. The chip includes a processor and a communication interface. The processor reads, through the communication interface, instructions stored in a memory, to perform the method according to any implementation of any one of the first aspect to the ninth aspect.

Optionally, in an implementation, the chip further includes the memory. The memory stores a computer program or the instructions. The processor is configured to execute the computer program or the instructions stored in the memory. When the computer program or the instructions are executed, the processor is configured to perform the method according to any implementation of any one of the first aspect to the ninth aspect.

According to a sixteenth aspect, a communication system is provided, including the control node in the first aspect and the first network node in the second aspect.

Optionally, the communication system further includes a second network node.

According to a seventeenth aspect, a communication system is provided, including the first network node in the third aspect and the second network node in the fourth aspect.

According to an eighteenth aspect, a communication system is provided, including the network node in the fifth aspect and the terminal apparatus in the sixth aspect.

### BRIEF DESCRIPTION OF DRAWINGS

FIG. 1 is a diagram of a wireless communication system 100 applicable to embodiments of the present disclosure;

FIG. 2 is a diagram of a wireless communication system according to an embodiment of the present disclosure;

FIG. 3 is a diagram of an AI task indication method 300 according to an embodiment of the present disclosure;

FIG. 4 is a diagram of an AI task indication method 400 according to another embodiment of the present disclosure;

FIG. 5 is a diagram of an AI task indication method 500 according to another embodiment of the present disclosure;

FIG. 6 is a schematic flowchart of an AI task indication method 600 according to an embodiment of the present disclosure;

FIG. 7 is a diagram applicable to an embodiment of the present disclosure;

FIG. 8 is a schematic flowchart of an AI task indication method 800 according to another embodiment of the present disclosure;

FIG. 9 is a schematic flowchart of an AI task indication method 900 according to another embodiment of the present disclosure;

FIG. 10 is a schematic block diagram of a communication apparatus 1000 according to an embodiment of the present disclosure;

FIG. 11 is a schematic block diagram of a communication apparatus 1100 according to an embodiment of the present disclosure; and

FIG. 12 is a schematic block diagram of a chip system 1200 according to an embodiment of the present disclosure.

### DESCRIPTION OF EMBODIMENTS

Technical solutions of the present disclosure are described below with reference to the accompanying drawings.

First, related concepts and technologies in the present disclosure are briefly described.

1. An artificial intelligence (AI) model is an algorithm or a computer program that can implement an AI function. The AI model represents a mapping relationship between an input and an output of the model, or the AI model is a function model that maps an input of a specific dimension to an output of a specific dimension. A parameter of the function model may be obtained through machine learning training. For example, f(x)=ax²+b is a quadratic function model, and may be considered as an AI model, where a and b are parameters of the AI model, and a and b may be obtained through machine learning training.

It may be understood that the AI model may be implemented by a hardware circuit, or may be implemented by software, or may be implemented by a combination of software and hardware. This is not limited. A non-limitative example of the software includes program code, a program, a subprogram, an instruction, an instruction set, code, a code segment, a software module, an application program, a software application program, or the like.

2. A dataset includes data used for model training, model verification, or model testing in machine learning. An amount and quality of the data affect effect of machine learning.

3. Model training is to select a proper loss function and train a model parameter based on an optimization algorithm, to minimize a loss function value. The loss function is used to measure a difference between a predicted value and an actual value of a model.

4. An AI task indicates a task related to AI. In an example, the AI task may include, for example, a task related to a model (for example, an AI model), or a task related to a dataset.

The following briefly describes a communication system applicable to the present disclosure.

The technical solutions provided in the present disclosure may be applied to various communication systems, for example, a 5th generation (5G) or new radio (NR) system, a long term evolution (LTE) system, an LTE frequency division duplex (FDD) system, and an LTE time division duplex (TDD) system. The technical solutions provided in the present disclosure may be further applied to a future communication system, for example, a 6th generation mobile communication system. The technical solutions provided in the present disclosure may be further applied to device-to-device (D2D) communication, vehicle-to-everything (V2X) communication, machine-to-machine (M2M) communication, machine type communication (MTC), an internet of things (IoT) communication system, or another communication system.

A terminal device in embodiments of the present disclosure includes various devices having a wireless communication function, and the terminal device may be configured to be connected to a person, an object, a machine, and the like. The terminal device may be widely applied to various scenarios, for example, cellular communication, D2D, V2X, peer-to-peer (P2P), M2M, MTC, IoT, virtual reality (VR), augmented reality (AR), industrial control, autonomous driving, telemedicine, smart grid, smart furniture, smart office, smart wear, smart transportation, a smart city drone, a robot, remote sensing, passive sensing, positioning, navigation and tracking, and autonomous delivery. The terminal device may be a terminal in any one of the foregoing scenarios, for example, an MTC terminal or an IoT terminal. The terminal device may be user equipment (UE) in a 3rd generation partnership project (3GPP) standard, a terminal, a fixed device, a mobile station device, namely, a mobile device, a subscriber unit, a handheld device, a vehicle-mounted device, a wearable device, a cellular phone, a smartphone, a SIP phone, a wireless data card, a personal digital assistant (PDA), a computer, a tablet computer, a notebook computer, a wireless modem, a handheld device (or handset), a laptop computer, a computer having a wireless transceiver function, a smart book, a vehicle, a satellite, a global positioning system (GPS) device, a target tracking device, a flight device (for example, an uncrewed aerial vehicle, a helicopter, a multi-helicopter, a four-helicopter, or an airplane), a ship, a remote control device, a smart home device, or an industrial device; or may be an apparatus built in the foregoing device (for example, a communication module, a modem, or a chip in the foregoing device); or may be another processing device connected to the wireless modem. For ease of description, an example in which the terminal device is a terminal or UE is used for description below.

It should be understood that, in some scenarios, the UE may further serve as a base station. For example, the UE may act as a scheduling entity, and provides a sidelink signal between UEs in a V2X scenario, a D2D scenario, a P2P scenario, or the like.

In embodiments of the present disclosure, an apparatus configured to implement a function of the terminal device may be a terminal device; or may be an apparatus that can support the terminal device in implementing the function, for example, a chip system or a chip. The apparatus may be installed in the terminal device. In embodiments of the present disclosure, the chip system may include a chip or may include a chip and another discrete component.

A network device in embodiments of the present disclosure may be a device configured to communicate with the terminal device. The network device may alternatively be referred to as an access network device or a radio access network device. For example, the network device may be a base station. A network device in embodiments of the present disclosure may be a radio access network (RAN) node (or device) that connects the terminal device and a wireless network. The base station may cover various names in the following in a broad sense, or may be replaced with the following names, for example, a NodeB, an evolved NodeB (eNB), a next generation NodeB (gNB), a relay station, an access point, a transmission and reception point (TRP), a transmission point (TP), a primary station, a secondary station, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. The base station may alternatively be a communication module, a modem, or a chip that is disposed in the foregoing device or apparatus. The base station may alternatively be a mobile switching center, a device that assumes a base station function in D2D, V2X, and M2M communication, a network side device in a 6G network, a device that assumes a base station function in a future communication system, or the like. The base station may support networks of a same access technology or different access technologies. A specific technology and a specific device form that are used for the network device are not limited in embodiments of the present disclosure.

The base station may be stationary or mobile. For example, a helicopter or an uncrewed aerial vehicle may be configured to serve as a mobile base station, and at least one cell may move based on a location of the mobile base station. In another example, a helicopter or an uncrewed aerial vehicle may be configured as a device for communicating with another base station.

The network device and the terminal device may be deployed on land, including an indoor or outdoor device, a hand-held device, or a vehicle-mounted device; may be deployed on water; or may be deployed on an airplane, a balloon, and a satellite in the air. Scenarios in which the network device and the terminal device are located are not limited in embodiment of the present disclosure.

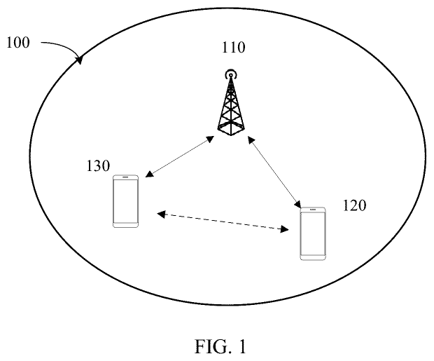

In an example, FIG. 1 is a diagram of a wireless communication system 100 applicable to embodiments of the present disclosure. As shown in FIG. 1, the wireless communication system 100 may include at least one network device, for example, a network device 110 shown in FIG. 1. The wireless communication system 100 may further include at least one terminal device, for example, a terminal device 120 and a terminal device 130 shown in FIG. 1. A plurality of antennas may be configured for both the network device and the terminal device, and the network device and the terminal device may communicate with each other by using a multi-antenna technology. The terminal devices may directly communicate with each other.

When the network device communicates with the terminal device, the network device may manage at least one cell, and there may be at least one terminal device in one cell. Optionally, the network device 110 and the terminal device 120 form a single-cell communication system. Without loss of generality, the cell is referred to as a cell #1. The network device 110 may be a network device in the cell #1, or the network device 110 may serve a terminal device (for example, the terminal device 120) in the cell #1.

It should be noted that the cell may be understood as an area within a coverage area of a radio signal of the network device.

It should be understood that FIG. 1 is merely a simplified schematic of an example for ease of understanding. The wireless communication system 100 may further include another network device or may further include another terminal device, which is not shown in FIG. 1. Embodiments of the present disclosure are applicable to any communication scenario in which a transmitting end device communicates with a receiving end device.

To cope with the vision of intelligence and inclusiveness in the future, intelligence further evolves at a level of a wireless network architecture. AI is further integrated with a wireless network deeply to achieve network native intelligence and terminal intelligence, thereby meeting some possible new requirements and new scenarios. For example, in a possible scenario, terminal types are diversified, and terminal connections are more flexible and intelligent. The terminal types are diversified. In a supper internet of things (supper IoT) (for example, an internet of things, an internet of vehicles, industry, and medical treatment) scenario and a scenario with massive connections, the terminal connections are more flexible, and the terminal has a specific AI capability. For another example, a possible requirement is network native intelligence. In addition to a conventional communication connection service, the network may further provide computing and AI services, to better support an inclusive, real-time, and highly secure AI service. These new requirements and new scenarios may bring changes to a wireless network architecture and a communication mode.

Currently, 3GPP introduces AI capabilities by adding a network data analytics function (NWDAF) to a 5G network. Main functions of the NWDAF include: collecting data from another network function (NF) and an application function (AF), collecting data from a network operations and maintenance system (for example, an operation, administration and maintenance (OAM)), and providing a metadata exposure service, a data analytics service, and the like for the NF or the AF. The NWDAF is introduced mainly for automatic and intelligent network operation and maintenance, network performance and service experience optimization, end-to-end service level agreement (SLA) assurance, and the like. An AI model trained by the NWDAF may be applied to network fields such as mobility management, session management, and network automation, and an AI method is used to replace a numerical formula-based method in an original network function. However, the NWDAF is deployed in a core network and is an external AI unit. The NWDAF is not strongly coupled to a communication network and has limited performance.

Based on possible scenarios and requirements faced by a future wireless network, a quantity of terminal devices and types of the intelligent terminals in the communication network may also increase rapidly. A large amount of data collected, processed, and generated by the intelligent terminals may provide a driving force for application of AI technologies. Under such a background, a large quantity of AI nodes may be deployed in the wireless network. Correspondingly, a large amount of AI-related traffic is generated between AI nodes, for example, a dataset, an AI model, and an intermediate parameter. Therefore, a transmission mechanism for the AI-related traffic can be designed, so that the network and AI can be more closely combined, to provide a better AI service.

Based on this, the present disclosure proposes maintaining an AI capability of each network node in a wireless network. In this way, each network node may be orchestrated based on the AI capability of each network node. To be specific, how the network nodes cooperatively process an AI task is determined. Alternatively, the network node may obtain AI capability information of another network node based on a requirement, so that a plurality of network nodes can cooperatively process the AI task.

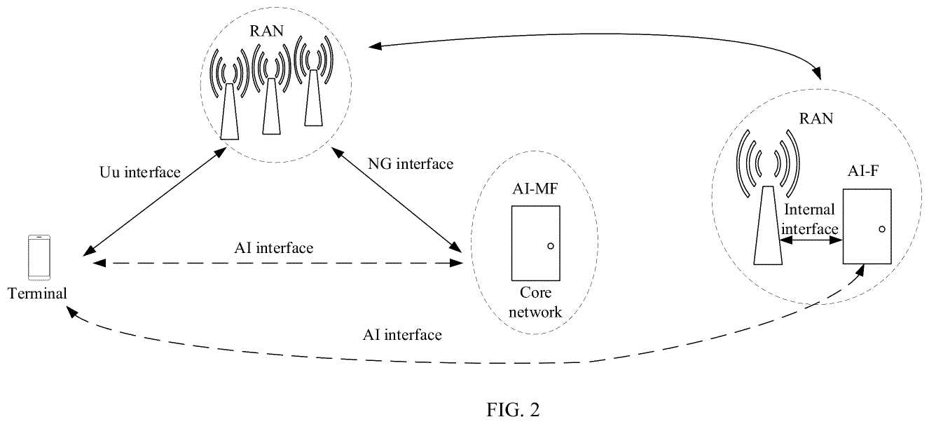

In an example, FIG. 2 is a diagram of a wireless communication system according to an embodiment of the present disclosure. As shown in FIG. 2, the wireless communication system may include a network node, for example, a RAN. The wireless communication system may further include an AI node, for example, an AI management function (AI-MF) and an AI function (AI-F). The network node and the AI node may directly communicate with each other, or may indirectly communicate with each other (for example, communicate with each other through forwarding by another node).

Optionally, the AI node may store or maintain an AI capability of the network node. The AI capability of the network node may also be referred to as an AI-related parameter of the network node. The AI capability of the network node is used for uniform description below.

The AI capability of the network node may include, for example, at least one of the following: a priority of the network node, computing power supported by the network node (for example, maximum computing power supported by the network node), a hardware capability of the network node, an AI task supported by the network node, performance of a local AI model of the network node, and performance of a local dataset of the network node. In an example, the priority of the network node may be determined based on a historical response state of the network node. For example, if the network node participates in cooperative processing of the AI task for a large quantity of times, the priority of the network node is high; or if the network node participates in cooperative processing of the AI task for a small quantity of times, the priority of the network node is low. In another example, the priority of the network node may be determined based on a capability of the network node (for example, supported computing power, or a hardware capability of the network node). For example, if the capability of the network node is high, the priority of the network node is high; or if the capability of the network node is low, the priority of the network node is low.

It may be understood that the foregoing is example descriptions, and is not limited thereto. For example, the AI capability of the network node may further include a security requirement of the network node.

Optionally, the AI node is deployed in a core network; or the AI node is deployed outside a core network. For example, the AI node may be deployed in a network node. For another example, the AI node is an operation and maintenance management system independently configured by an operator. In an example, as shown in FIG. 2, the AI node AI-MF may be deployed in the core network, and the RAN may communicate with the AI-MF through an NG interface. In another example, as shown in FIG. 2, the AI node AI-F may be deployed in the RAN, and another module in the RAN may communicate with the AI-F through an internal interface.

It may be understood that the AI node may be an independent device, or may be integrated into a same device to implement some functions, or may be a network element in a hardware device, or may be a software function running on dedicated hardware, or may be an instantiated virtualization function on a platform (for example, a cloud platform). A specific form of the AI node is not limited in the present disclosure.

It may be further understood that FIG. 2 shows example descriptions. The present disclosure is not limited thereto. For example, the communication system shown in FIG. 2 may further include more devices, for example, more terminals, more AI nodes, or more network nodes.

The communication system provided in this embodiment of the present disclosure is briefly described above with reference to FIG. 2. The following describes a method provided in embodiments of the present disclosure. The method described below may be applied to the system shown in FIG. 2.

It should be noted that in the present disclosure, “indication” may include a direct indication, an indirect indication, an explicit indication, and an implicit indication. When a piece of indication information is described as indicating A, it may be understood that the indication information carries A, directly indicates A, or indirectly indicates A.

In the present disclosure, information indicated by the indication information is referred to as to-be-indicated information. In a specific implementation process, the to-be-indicated information is indicated in a plurality of manners, for example, but not limited to, the following manners: The to-be-indicated information, for example, the to-be-indicated information or an index of the to-be-indicated information, may be directly indicated. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of all pieces of information that is pre-agreed on (for example, stipulated in a protocol), to reduce indication overheads to some extent.

The to-be-indicated information may be sent as a whole or may be divided into a plurality of pieces of sub-information for separate sending. In addition, sending periodicities and/or sending occasions of these pieces of sub-information may be the same or may be different. A specific sending method is not limited in the present disclosure. The sending periodicities and/or the sending occasions of these pieces of sub-information may be predefined, for example, predefined according to a protocol, or may be configured by a transmitting end device by sending configuration information to a receiving end device. The configuration information may include, for example, but not limited to, one or a combination of at least two of radio resource control signaling, media access control (MAC) layer signaling, and physical layer signaling. The radio resource control signaling includes, for example, radio resource control (RRC) signaling. The MAC layer signaling includes, for example, a MAC control element (CE). The physical layer signaling includes, for example, downlink control information (DCI).

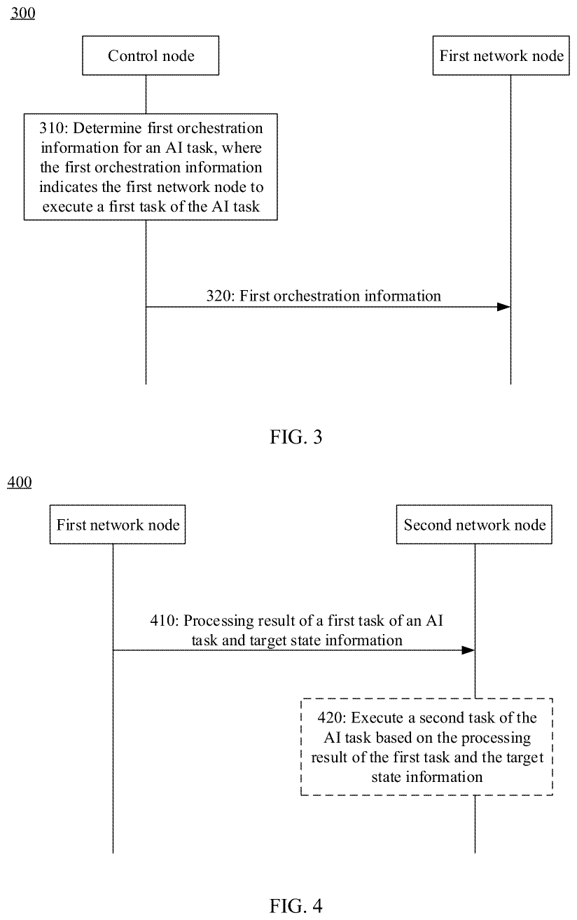

In an example, FIG. 3 is a diagram of an AI task indication method 300 according to an embodiment of the present disclosure. The method 300 may include the following steps.

310: A control node determines first orchestration information for an AI task, where the first orchestration information indicates a first network node to execute a first task of the AI task.

The AI task may be determined by the control node, or may be requested by another node (for example, a network node, a terminal, a core network node, or an AI node). This is not limited.

The control node may be, for example, an AI node, for example, an AI-MF or an AI-F shown in FIG. 2. The network node may be, for example, a network device, for example, a RAN shown in FIG. 2.

The first network node may be the 1st network node participating in execution of the AI task, or the first network node may be any network node participating in execution of the AI task.

For example, it is assumed that two network nodes participate in execution of the AI task, and the two network nodes are the first network node and a second network node. If the first network node first executes the AI task, for example, the first network node executes a part (for example, denoted as a first task) of the AI task, and after the first network node completes execution of the first task of the AI task, the second network node continues to execute the AI task, for example, the second network node executes the other part (for example, denoted as a second task) of the AI task, the first network node may be considered as the 1st network node participating in execution of the AI task, and the second network node may be considered as a next network node (or referred to as a next-hop network node) of the first network node.

That the first orchestration information indicates the first network node to execute the first task of the AI task may be that the first orchestration information directly indicates the first network node to execute the first task of the AI task, for example, the first orchestration information includes the first task; or may be that the first orchestration information indirectly indicates the first network node to execute the first task of the AI task, for example, the first orchestration information includes other information, and the other information may indirectly indicate the first task.

Optionally, the first orchestration information includes at least one piece of the following information: the first task, an identifier of the first network node, a resource provided for executing the first task by the first network node, or an exit condition of executing the first task by the first network node.

(1) The first task indicates a part (or referred to as a decomposed task) that is of the AI task and for which the first network node is responsible when the first network node participates in execution of the AI task, or an operation provided when the first network node participates in execution of the AI task.

If the first orchestration information includes the first task, the first orchestration information may directly indicate the first network node to execute the first task of the AI task. To be specific, the first network node may directly learn, based on the first orchestration information, of an operation that needs to be provided when the AI task is executed, and then execute the first task based on the first orchestration information.

(2) The identifier of the first network node is used to identify that a network node participating in execution of the AI task includes the first network node.

If the first orchestration information includes the identifier of the first network node, the first orchestration information may indirectly indicate the first network node to execute the first task of the AI task. Specifically, the first network node may learn, based on the identifier of the first network node in the first orchestration information, that the first network node needs to participate in execution of the AI task. In this case, the first network node may participate in execution of the AI task based on an AI capability of the first network node. In this way, the first network node may determine, based on the AI capability of the first network node, the operation that needs to be provided when the AI task is executed, to be specific, determine the first task.

(3) The resource provided for executing the first task by the first network node indicates a resource that needs to be provided when the first network node participates in execution of the AI task, for example, computing power that needs to be provided, or a hardware capability that needs to be provided.

If the first orchestration information includes the resource provided for executing the first task by the first network node, the first orchestration information may indirectly indicate the first network node to execute the first task of the AI task. Specifically, the first network node may execute the AI task based on the resource provided for executing the first task by the first network node in the first orchestration information. In this way, the first network node may determine, based on the resource, when to stop executing the AI task, to determine the operation that needs to be provided when the AI task is executed, to be specific, determine the first task.

(4) The exit condition of executing the first task by the first network node indicates a condition in which the first network node transfers the AI task to a next network node for further processing, namely, a condition in which the first network element node stops executing the AI task and may be used by the first network node to determine when to stop executing the AI task.

If the first orchestration information includes the exit condition of executing the first task by the first network node, the first orchestration information may indirectly indicate the first network node to execute the first task of the AI task. Specifically, the first network node may execute the AI task based on the exit condition of executing the first task by the first network node. In this way, the first network node may determine, based on the exit condition, when to stop executing the AI task, and further determine the operation that needs to be provided when the AI task is executed, to be specific, determine the first task.

It may be understood that, for a last network element node, an exit condition of executing the AI task by the last network element node is a condition in which the last network element node stops executing the AI task, and the last network node does not need to transfer the AI task to another network node (for example, a next network node). For example, if the first network node is the last network node, to be specific, the first network element node obtains a final result of the AI task after the first network element node executes the first task based on the exit condition of executing the first task by the first network node, in an example, the first network element node may directly send the final result of the AI task to an initiation node (for example, the terminal device) of the AI task, or the first network element node may send the final result of the AI task to another node, and the another node sends the final result of the AI task to the initiation node of the AI task.

320: The control node sends the first orchestration information to the first network node.

Optionally, the method 300 further includes: The first network node executes the first task of the AI task based on the first orchestration information.

Based on this embodiment of the present disclosure, the control node may determine orchestration information for the AI task, and send the orchestration information to a network node, so that the network node can execute the AI task based on the orchestration information. In this manner, the control node may determine proper orchestration information based on the AI task, to improve global efficiency.

Optionally, that a control node determines first orchestration information for an AI task includes: The control node determines an orchestration table of the AI task for the AI task. The orchestration table includes orchestration information of N network nodes, the N network nodes include the first network node, and N is an integer greater than 1 or equal to 1. In this way, the control node may perform unified orchestration, to improve global efficiency. The orchestration table includes the orchestration information of the N network nodes. In other words, the orchestration information of the N network nodes may be considered as an orchestration table.

For example, it is assumed that the N network nodes include the first network node and the second network node, the control node determines the first orchestration information and second orchestration information for the AI task, and the second orchestration information indicates the second network node to execute the second task of the AI task. For orchestration information of each network node, refer to the foregoing description of the orchestration information (namely, the first orchestration information) of the first network node. Details are not described herein again.

In an example, the orchestration table may exist, for example, stored or transmitted, in a form of a table, a function, or a character string. Table 1 shows an example of presenting the orchestration table in a form of a table.

TABLE 1

| | |
|---|---|
| Network node | Orchestration information of a network node |
| First network node | First orchestration information |
| Second network node | Second orchestration information |

Table 1 is used as an example. The orchestration information of the first network node is the first orchestration information. In other words, the first orchestration information indicates the first network node to execute the first task of the AI task. The orchestration information of the second network node is the second orchestration information. In other words, the second orchestration information indicates the second network node to execute the second task of the AI task.

It may be understood that Table 1 shows merely example descriptions, and sets no limitation thereto. Any variation of Table 1 is applicable to the embodiments illustrated in the present disclosure. For example, Table 1 may further include more network nodes.

For example, the orchestration information of each network node may be transmitted in any one of the following manners.

In a first possible implementation, the control node sends the orchestration table to each of the N network nodes.

Based on this implementation, each of the N network nodes may learn of the orchestration table from the control node and may learn of respective orchestration information based on the orchestration table.

For example, it is assumed that the N network nodes include the first network node and the second network node, the orchestration table includes the orchestration information of the first network node and the orchestration information of the second network node, the orchestration information of the first network node is the first orchestration information, and the orchestration information of the second network node is the second orchestration information. Based on this implementation, the control node sends the first orchestration information and the second orchestration information to the first network node, and the control node sends the first orchestration information and the second orchestration information to the second network node.

In a second possible implementation, the control node sends the orchestration table to one (for example, the first network node) of the N network nodes.

The first network node may be the 1st network node participating in execution of the AI task, or the first network node may be any network node participating in execution of the AI task.

Example 1: The first network node sends the orchestration table to another network node in the N network nodes. For example, after receiving the orchestration table, the first network node may directly send the orchestration table to the another network node in the N network nodes. For another example, after executing, based on the orchestration table, a task for which the first network node is responsible in the AI task, the first network node sends the orchestration table to another network node in the N network nodes.

For example, it is assumed that the N network nodes include the first network node and the second network node, the orchestration table includes the orchestration information of the first network node and the orchestration information of the second network node, the orchestration information of the first network node is the first orchestration information, and the orchestration information of the second network node is the second orchestration information. Based on Example 1, the control node sends the first orchestration information and the second orchestration information to the first network node, and the first network node sends the first orchestration information and the second orchestration information to the second network node.

Example 2: The first network node sends orchestration information of another network node in the N network nodes to the another network node. For example, after receiving the orchestration table, the first network node may directly send the orchestration information of the another network node in the N network nodes in the orchestration table to the another network node. For another example, after executing, based on the orchestration table, a task for which the first network node is responsible in the AI task, the first network node sends the orchestration information of the another network node in the N network nodes in the orchestration table to the another network node.

For example, it is assumed that the N network nodes include the first network node and the second network node, the orchestration table includes the orchestration information of the first network node and the orchestration information of the second network node, the orchestration information of the first network node is the first orchestration information, and the orchestration information of the second network node is the second orchestration information. Based on Example 2, the control node sends the first orchestration information and the second orchestration information to the first network node, and the first network node sends the second orchestration information to the second network node.

Example 3: The first network node sends the orchestration table to the next network node of the first network node, the next network node sends the orchestration table to a next network node of the next network node, and so on. For example, after receiving the orchestration table, the first network node may directly send the orchestration table to the next network node of the first network node. For another example, after executing, based on the orchestration table, a task for which the first network node is responsible in the AI task, the first network node sends the orchestration table to the next network node of the first network node.

For example, it is assumed that the N network nodes include the first network node, the second network node, and a third network node, the orchestration table includes the orchestration information of the first network node, the orchestration information of the second network node, and orchestration information of the third network node, the orchestration information of the first network node is the first orchestration information, the orchestration information of the second network node is the second orchestration information, and the orchestration information of the third network node is third orchestration information. Based on Example 3, the control node sends the first orchestration information, the second orchestration information, and the third orchestration information to the first network node, the first network node sends the first orchestration information, the second orchestration information, and the third orchestration information to the second network node, and the second network node sends the first orchestration information, the second orchestration information, and the third orchestration information to the third network node.

Example 4: The first network node sends orchestration information other than the orchestration information of the first network node in the orchestration table to the next network node of the first network node, the next network node sends, to a next network node of the next network node, orchestration information other than orchestration information of the next network node in the orchestration table received from the first network node, and so on. For example, after receiving the orchestration table, the first network node may directly send the orchestration information other than the orchestration information of the first network node in the orchestration table to the next network node of the first network node. For another example, after executing, based on the orchestration table, a task for which the first network node is responsible in the AI task, the first network node sends the orchestration information other than the orchestration information of the first network node in the orchestration table to the next network node of the first network node.

For example, it is assumed that the N network nodes include the first network node, the second network node, and a third network node, the orchestration table includes the orchestration information of the first network node, the orchestration information of the second network node, and orchestration information of the third network node, the orchestration information of the first network node is the first orchestration information, the orchestration information of the second network node is the second orchestration information, and the orchestration information of the third network node is third orchestration information. Based on Example 4, the control node sends the first orchestration information, the second orchestration information, and the third orchestration information to the first network node, the first network node sends the second orchestration information and the third orchestration information to the second network node, and the second network node sends the third orchestration information to the third network node.

In a third possible implementation, the control node sends the orchestration information of each network node to each of the N network nodes.

For example, it is assumed that the N network nodes include the first network node and the second network node, the orchestration table includes the orchestration information of the first network node and the orchestration information of the second network node, the orchestration information of the first network node is the first orchestration information, and the orchestration information of the second network node is the second orchestration information. Based on this implementation, the control node sends the first orchestration information to the first network node, and the control node sends the second orchestration information to the second network node.

It may be understood that the foregoing several possible implementations are example descriptions, and set no limitation thereto. For example, the control node may also send the orchestration table to some network nodes in the N network nodes, and then the some network nodes send the orchestration table or the orchestration information of each network node to another network node.

It may be further understood that, in any one of the foregoing possible implementations, when the first network node sends the orchestration information of the second network node to the second network node, the first network node may further send a processing result of the first task to the second network node. In this way, the second network node may continue to execute the AI task based on the processing result of the first task.

Optionally, the control node determines the orchestration table for the AI task based on AI capabilities of the N network nodes. For example, the control node determines the first orchestration information for the AI task based on the AI capability of the first network node. In this way, the orchestration information determined by the control node may match an AI capability of each network node, to reduce a probability that the network node cannot execute the AI task.

As described above, the AI capability of the network node may include, for example, at least one of the following: a priority of the network node, computing power supported by the network node, a hardware capability of the network node, an AI task supported by the network node, performance of a local AI model of the network node, and performance of a local dataset of the network node. With reference to the AI capability of the network node, the following lists several examples in which the control node determines the orchestration table for the AI task based on the AI capabilities of the N network nodes.

Example 1: The control node determines the orchestration table for the AI task based on the AI task supported by the network node. In other words, the control node determines the orchestration information of the network node for the AI task based on the AI task supported by the network node.

For example, if the AI task is a model training task, the control node may determine, based on an AI task supported by each network node, network nodes that support the model training task, and the control node may determine, from the network nodes that support the model training task, N network nodes that participate in execution of the AI task. In addition, an operation for which each of the N network nodes is responsible, a resource provided by each of the N network nodes, and the like may be determined by the control node based on another AI capability of the network node, or may be independently determined by each network node based on an AI capability of the network node in a process in which the network node executes the AI task. This is not limited.

Example 2: The control node determines the orchestration table for the AI task based on the computing power supported by the network node. In other words, the control node determines the orchestration information of the network node for the AI task based on the computing power supported by the network node.

For example, the control node determines, based on the computing power supported by each network node, that N network nodes with high computing power execute the AI task. In addition, the control node may further determine, based on computing power supported by the N network nodes, an operation for which each network node is responsible and/or a resource provided by each network node. It may be understood that an operation for which each of the N network nodes is responsible, a resource provided by each of the N network nodes, and the like may also be determined by the control node based on another AI capability of the network node, or may be independently determined by each network node based on an AI capability of the network node in a process in which the network node executes the AI task. This is not limited.

Example 3: The control node determines the orchestration table for the AI task based on the hardware capability of the network node. In other words, the control node determines the orchestration information of the network node for the AI task based on the hardware capability of the network node.

For example, the control node determines, based on a hardware capability of each network node, that N network nodes with high hardware capabilities execute the AI task. In addition, the control node may further determine, based on hardware capabilities of the N network nodes, an operation for which each network node is responsible and/or a resource provided by each network node. It may be understood that an operation for which each of the N network nodes is responsible, a resource provided by each of the N network nodes, and the like may also be determined by the control node based on another AI capability of the network node, or may be independently determined by each network node based on an AI capability of the network node in a process in which the network node executes the AI task. This is not limited.

Example 4: The control node determines the orchestration table for the AI task based on the performance of the local AI model of the network node. In other words, the control node determines the orchestration information of the network node for the AI task based on the performance of the local AI model of the network node.

In an example, the performance of the local AI model of the network node may include but is not limited to accuracy and timeliness. The accuracy may represent performance of the AI model when the AI model executes several tasks. The timeliness may represent generation time of the AI model.

For example, the control node determines, based on the performance of the local AI model of the network node, that N network nodes with high performance execute the AI task. In addition, the control node may further determine, based on performance of local AI models of the N network nodes, an operation for which each network node is responsible and/or a resource provided by each network node. It may be understood that an operation for which each of the N network nodes is responsible, a resource provided by each of the N network nodes, and the like may also be determined by the control node based on another AI capability of the network node, or may be independently determined by each network node based on an AI capability of the network node in a process in which the network node executes the AI task. This is not limited.

Example 5: The control node determines the orchestration table for the AI task based on the performance of the local dataset of the network node. In other words, the control node determines the orchestration information of the network node for the AI task based on the performance of the local dataset of the network node.

In an example, the performance of the local dataset of the network node may include but is not limited to accuracy and timeliness. The accuracy may represent performance of the dataset in several test models. The timeliness may represent generation time of the dataset.

For example, the control node determines, based on the performance of the local dataset of the network node, that N network nodes with high performance execute the AI task. In addition, the control node may further determine, based on performance of local datasets of the N network nodes, an operation for which each network node is responsible and/or a resource provided by each network node. It may be understood that an operation for which each of the N network nodes is responsible, a resource provided by each of the N network nodes, and the like may also be determined by the control node based on another AI capability of the network node, or may be independently determined by each network node based on an AI capability of the network node in a process in which the network node executes the AI task. This is not limited.

Example 6: The control node determines the orchestration table based on the priority of the network node. In other words, the control node determines the orchestration information of the network node for the AI task based on the priority of the network node.

For example, the control node determines, based on the priority of the network node, that N network nodes with high priorities execute the AI task. In addition, an operation for which each of the N network nodes is responsible, a resource provided by each of the N network nodes, and the like may also be determined by the control node based on another AI capability of the network node, or may be independently determined by each network node based on an AI capability of the network node in a process in which the network node executes the AI task. This is not limited.

Example 7: The control node determines the orchestration table for the AI task based on the AI task supported by the network node and computing power supported by the N network nodes. In other words, the control node determines the orchestration information of the network node for the AI task based on the AI task supported by the network node and computing power supported by the N network nodes.

For example, if an AI task requested by a communication node is a model training task, the control node may determine, based on an AI task supported by each network node, network nodes that support the model training task, and the control node may determine, from the network nodes that support the model training task, N network nodes that participate in execution of the AI task. Further, the control node may determine, based on the computing power supported by the N network nodes, an operation for which each network node is responsible and a resource provided by each network node.

It may be understood that the foregoing several examples are example descriptions and set no limitation thereto. For example, the control node may determine the orchestration table for the AI task based on at least one of the following: the priority of the network node, the computing power supported by the network node, the hardware capability of the network node, the AI task supported by the network node, the performance of the local AI model of the network node, and the performance of the local dataset of the network node.

Optionally, the control node may learn of the AI capabilities of the N network nodes in any one of the following manners.

In a first possible implementation, the control node locally maintains an AI capability of at least one network node, and the control node may directly determine the orchestration table for the AI task based on the locally maintained AI capability of the at least one network node. The at least one network node includes N network nodes.

For example, the AI capability of the at least one network node may exist, for example, stored or transmitted, in a form of a table, a function, or a character string. Table 2 shows an example of presenting the AI capability of the at least one network node in a form of a table.

TABLE 2

| | |
|---|---|
| Network node | AI capability of a network node |
| First network node | AI capability of the first network node |
| Second network node | AI capability of the second network node |
| Third network node | AI capability of the third network node |

It may be understood that Table 2 shows merely example descriptions, and sets no limitation thereto. Any variation of Table 2 is applicable to the embodiments of the present disclosure. For example, Table 2 may further include more network nodes.

In a second possible implementation, after determining the AI task, the control node requests another node for an AI capability of at least one network node, and further may determine the orchestration table for the AI task based on the AI capability of the at least one network node. The at least one network node includes N network nodes.

In a third possible implementation, after determining the AI task, the control node requests at least one network node for an AI capability of the at least one network node, and further may determine the orchestration table for the AI task based on the AI capability of the at least one network node. The at least one network node includes N network nodes.

Optionally, the AI capability of the network node may be updated. The following describes two examples by using an example in which the control node maintains the AI capability of the network node.

In an example, the control node periodically updates the AI capability of the network node. For example, the network node periodically reports the AI capability of the network node to the control node, and further, the control node may periodically update the AI capability of the network node. For another example, the control node periodically sends information to the network node. The information is used to trigger the network node to report the AI capability of the network node to the control node. Further, the control node may periodically update the AI capability of the network node.

In another example, after an event is triggered, the control node updates the AI capability of the network node. For example, the network node reports the AI capability of the network node to the control node. If the AI capability reported by the network node is inconsistent with a previously stored AI capability of the network node, the control node updates the AI capability of the network node. For another example, after determining orchestration information for a specific AI task, the network node updates the AI capability of the network node.

Optionally, the method 300 further includes: The control node receives response information from the first network node. The response information indicates whether the first network node agrees with the first orchestration information.

In a possible case, the first network node agrees with the first orchestration information. Therefore, the response information sent by the first network node to the control node indicates that the first network node agrees with the first orchestration information.

In another possible case, the first network node disagrees with the first orchestration information. Therefore, the response information sent by the first network node to the control node indicates that the first network node disagrees with the first orchestration information.

Whether the first network node agrees with (or is referred to as “accepts”) the first orchestration information may be understood as whether the first network node agrees to execute the first task.

That the response information indicates whether the first network node agrees with the first orchestration information includes any one of the following implementations.

In a first possible implementation, the response information directly indicates whether the first network node agrees with the first orchestration information.

For example, the response information may be implemented by using an acknowledgment and a negative acknowledgment. For example, if the first network node agrees with the first orchestration information, the first network node sends the acknowledgment to the control node; or if the first network node disagrees with the first orchestration information, the first network node sends the negative acknowledgment to the control node.

For another example, the response information may be implemented by using at least one bit. For example, it is assumed that one bit indicates whether the first network node agrees with the first orchestration information. If the bit is set to “1”, it indicates that the first network node agrees with the first orchestration information; or if the bit is set to “0”, it indicates that the first network node disagrees with the first orchestration information. It should be understood that the foregoing is merely example descriptions and sets no limitation thereto.

In a second possible implementation, the response information indirectly indicates whether the first network node agrees with the first orchestration information.

For example, the first network node sends adjusted first orchestration information of the first network node to the control node. The adjusted first orchestration information may indirectly indicate that the first network node disagrees with the first orchestration information. In other words, the control node learns, based on the adjusted first orchestration information, that the first network node disagrees with the first orchestration information. For example, the adjusted first orchestration information may include but is not limited to an adjusted first task and/or a resource that can be provided when the first network node executes the first task.

It may be understood that the foregoing two implementations are example descriptions and set no limitation thereto. For example, if the control node does not receive the negative acknowledgment from the first network node within a period of time (denoted as a time period #1 for differentiation), the control node considers by default that the first network node agrees with the first orchestration information (equivalent to that the response information in an implicit form indicates that the first network node agrees with the first orchestration information). In an example, a start moment of the time period #1 may be a moment at which the control node sends the first orchestration information, and duration of the time period #1 may be predefined, or may be estimated based on a historical situation. This is not limited. In an example, the time period #1 may be implemented by using a timer.

In an example, when the first network node disagrees with the first orchestration information, the following several implementations may be included.

In a first possible implementation, the control node adjusts the first orchestration information. Based on this implementation, after learning that the first network node disagrees with the first orchestration information, the control node may redetermine the first orchestration information.

For example, it is assumed that the control node determines the orchestration table of the AI task for the AI task. The orchestration table includes the orchestration information of the N network nodes, and the N network nodes include the first network node. After learning that the first network node disagrees with the first orchestration information, the control node may redetermine the orchestration table.

In a second possible implementation, the first network node adjusts the first orchestration information, and sends the adjusted first orchestration information to the control node.

Based on this implementation, after disagreeing with the first orchestration information, the first network node may adjust the first orchestration information, and send the adjusted first orchestration information to the control node.

For example, it is assumed that the control node determines the orchestration table of the AI task for the AI task. The orchestration table includes the orchestration information of N network nodes, and the N network nodes include the first network node. For example, the control node may adjust, based on the adjusted first orchestration information, orchestration information of at least one network node other than the first network node in the N network nodes.

In a third possible implementation, the first network node sends the first task or a part of the first task to the second network node. The second network node is at least one network node participating in execution of the AI task.

The second network node may be determined by the first network node, for example, a neighboring network node selected by the first network node; or the second network node may be determined by the control node, for example, a next network node that is of the first network node and that is selected by the control node.

For example, the first network node directly and transparently transmits the first task to the second network node, and the second network node executes the first task. For another example, the first network node executes the part of the first task, and then sends the other part of the first task to the second network node, and the second network node executes the other part of the first task.

It may be understood that the foregoing several possible implementations are example descriptions and set no limitation thereto. For example, the first network node may execute the part of the first task, and then execute the other part of the first task.

Optionally, the network node schedules at least one terminal to participate in an operation of the network node. In other words, the at least one terminal and the network node jointly cooperatively execute the AI task. In this way, the at least one terminal is used to cooperatively execute the AI task, to reduce overheads caused by executing the AI task by the network node.

In an example, the at least one terminal may be a terminal for which the network node provides a communication service, or may be a terminal in a cell managed by the network node, or may be a terminal in a cell of the network node. For example, the network node may schedule the terminal in the cell of the network node to participate in the operation of the network node.

For example, the first network node is used as an example. Terminals in a cell of the first network node include a terminal #1 and a terminal #2, and the first network node may schedule at least one terminal to participate in an operation of the first network node, in other words, execute the first task. For example, the first network node sends the first task or the part of the first task to the at least one terminal.

In a possible implementation, the first network node executes the part of the first task, and the terminal #1 and/or the terminal #2 execute/executes the other part of the first task. Based on this implementation, in an example, a terminal participating in execution of the first task may send a processing result of execution of the first task to the first network node.

In another possible implementation, the terminal #1 and/or the terminal #2 execute/executes the first task.

For example, the terminal #1 or the terminal #2 executes the complete first task. In this case, in an example, a terminal that executes the complete first task may send a processing result of the first task to the first network node.

For another example, the terminal #1 and the terminal #2 separately execute the complete first task. In this case, in an example, the terminal #1 and the terminal #2 may send processing results of the first task to the first network node, and the first network node may perform an operation such as combination or selection on the processing results provided by the terminal #1 and the terminal #2.

For another example, the terminal #1 executes the part of the first task, and the terminal #2 executes the other part of the first task. In this case, in an example, the terminal #1 and the terminal #2 may send the processing results of the first task to the first network node, and the first network node may perform an operation such as combination or selection on the processing results provided by the terminal #1 and the terminal #2.

Optionally, the network node determines, based on an AI state of the terminal, whether the terminal participates in execution of the AI task. Specifically, detailed descriptions are provided below with reference to a method 500.

It may be understood that the method 300 is mainly described by using an example in which the control node determines the orchestration information of the network node for the AI task. This is not limited. In an example, the control node may alternatively determine orchestration information of at least one core network node for the AI task. In other words, the at least one core network node may cooperatively execute the AI task based on the orchestration information of the at least one core network node. In another example, the control node may alternatively determine orchestration information of at least one terminal for the AI task. In other words, the at least one terminal may cooperatively execute the AI task based on the orchestration information of the at least terminal.

In an example, FIG. 4 is a diagram of an AI task indication method 400 according to another embodiment of the present disclosure. The method 400 may include the following steps.

410: A first network node sends a processing result of a first task of an AI task and target state information to a second network node.

The target state information indicates a target result of the AI task, or the target state information indicates a final state of the AI task.

For example, that the AI task is a task related to a model is used as an example. The target state information indicates a final state of the model or may be used to describe a state of the model when the model stops flowing in a network. In an example, the target state information includes at least one piece of the following information: accuracy, timeliness, and a model structure. The accuracy may represent performance of the model when the model executes several tasks. The timeliness may represent generation time of the model.

For example, that the AI task is a task related to a dataset is used as an example. The target state information indicates a final state of the dataset or may be used to describe a state of the dataset when the dataset stops flowing in a network. In an example, the target state information includes at least one piece of the following information: accuracy, timeliness, a component, and an attribute. The accuracy may represent performance of the dataset in several test models. The timeliness may represent generation time of the dataset. The component may represent a component of data included in the dataset. The attribute can represent a type, quantization, a dimension, and the like of the data included in the dataset.

Optionally, the method 400 further includes step 420.

420: The second network node executes a second task of the AI task based on the processing result of the first task and the target state information.

The processing result of the first task and the target state information may implicitly indicate the second network node to participate in execution of the AI task. For example, the second network node executes the second task of the AI task. In other words, after receiving the processing result of the first task and the target state information, the second network node may learn that the second network node needs to participate in execution of the AI task.

Based on this embodiment of the present disclosure, network nodes may cooperatively execute the AI task, and determine, based on a current processing result and the target state information, whether to participate in execution of the AI task.

In an example, the processing result of the first task indicates current state information of the AI task. The current state information indicates a current result of the AI task, or the current state information indicates a current state of the AI task. In a possible case, the second network node receives the current state information of the AI task and the target state information, the second network node determines, based on inconsistency between the current state information and the target state information, to participate in execution of the AI task, and the second network node may execute the AI task by using the target state information as a final result of the AI task.

For example, that the AI task is a task related to a model is used as an example. The current state information indicates the current state of the model, namely, a state of the model when the model is generated by the first network node. In an example, the current state information includes at least one piece of the following information: accuracy, timeliness, and a model structure. For descriptions of each piece of information, refer to the related descriptions in step 410. Details are not described herein again.

For example, that the AI task is a task related to a dataset is used as an example. The current state information indicates the current state of the dataset, namely, a state of the dataset when the dataset is generated by the first network node. In an example, the current state information includes at least one piece of the following information: accuracy, timeliness, a component, and an attribute. For descriptions of each piece of information, refer to the related descriptions in step 410. Details are not described herein again.

Optionally, that a first network node sends a processing result of a first task of an AI task and target state information to a second network node in step 410 includes: The first network node sends the processing result of the first task of the AI task and the target state information to the second network node based on an AI capability of the second network node.

For example, if the first network node learns, based on the AI capability of the second network node, that the second network node supports the AI task, the first network node sends the processing result of the first task of the AI task and the target state information to the second network node.

For another example, if the first network node learns, based on the AI capability of the second network node, that computing power supported by the second network node meets a preset value, the first network node sends the processing result of the first task of the AI task and the target state information to the second network node. The preset value may be predefined, for example, predefined in a protocol, or may be estimated based on a historical situation. This is not limited.

For another example, if the first network node learns, based on the AI capability of the second network node, that performance of a local AI model of the second network node meets a preset condition, the first network node sends the processing result of the first task of the AI task and the target state information to the second network node. The preset condition may be predefined, for example, predefined in a protocol, or may be estimated based on a historical situation. This is not limited.

The first network node and the second network node may meet any one of the following:
In an example, the first network node and the second network node are adjacent network nodes. The adjacent network nodes may be, for example, network nodes at adjacent locations, or network nodes having an adjacent relationship in a network topology.

In another example, a relative location between the first network node and the second network node meets a preset condition. The relative location between the first network node and the second network node may be understood as a location of the second network node relative to the first network node by using the first network node as a reference, or may be described as a location of the first network node relative to the second network node by using the second network node as a reference. The relative location may include a distance and/or an angle.

It may be understood that the foregoing descriptions about the first network node and the second network node are example descriptions. This embodiment of the present disclosure is not limited thereto. For example, the second network node is a network node that can provide a service for a terminal. Specifically, after receiving a task request of the terminal for an AI task, the first network node may obtain an AI capability of the second network node that can provide the service for the terminal. For another example, the second network node may be a network node that previously cooperates with the first network node to execute the AI task. For another example, the second network node may be any network node.

The first network node may learn of the AI capability of the second network node in any one of the following manners.

In a first possible implementation, the first network node obtains the AI capability of the second network node from a control node.

In an example, the first network node queries the control node of the first network node for the AI capability of the second network node. For example, the first network node sends first request information to the control node. The first request information is used to request the AI capability of the second network node. The control node sends response information of the first request information to the first network node based on a request of the first network node. The response information indicates the AI capability of the second network node. The response information may directly indicate the AI capability of the second network node. For example, the response information includes the AI capability of the second network node. Alternatively, the response information may indirectly indicate the AI capability of the second network node. For example, the response information includes other information. The AI capability of the second network node may be indirectly learned of based on the other information.

For example, when the first network node cannot complete the AI task, the first network node may query the control node for the AI capability of the second network node. In this way, whether to obtain the AI capability of the second network node from the control node may be determined based on an actual situation. For example, if the AI capability of the first network node cannot complete the AI task, the first network node may request another network node (for example, the second network node) to cooperatively complete the AI task. Therefore, the first network node may obtain the AI capability of the second network node from the control node, to determine, based on the AI capability of the second network node, whether the second network node may cooperatively complete the AI task.

In another example, the first network node subscribes to the AI capability of the second network node from the control node. For example, the first network node subscribes to the AI capability of the second network node from the control node. After learning of the AI capability of the second network node, the control node sends the AI capability of the second network node to the first network node in response to a subscription of the first network node. In other words, the first network node first obtains the AI capability of the second network node from the control node, and stores the AI capability of the second network node. In this way, after the AI task is determined, the AI capability of the second network node may be directly used, to reduce a delay caused by executing the AI task.

In a second possible implementation, the first network node obtains the AI capability of the second network node from the second network node.

In an example, the first network node queries the second network node for the AI capability of the second network node. For example, the first network node sends first request information to the second network node. The first request information is used to request the AI capability of the second network node. The second network node sends response information of the first request information to the first network node based on a request of the first network node. The response information indicates the AI capability of the second network node.

In another example, the first network node subscribes to the AI capability of the second network node from the second network node.

For the foregoing two examples, refer to the descriptions in the first possible implementation. Details are not described herein again.

It may be understood that the foregoing implementations are example descriptions. This embodiment of the present disclosure is not limited thereto. For example, the control node may alternatively actively send the AI capability of the second network node to the first network node. For another example, the first network node may alternatively obtain the AI capability of the second network node from another network node or a core network node.

Optionally, before step 410, the method 400 further includes: The first network node sends second request information to the second network node. The second request information requests the second network node to cooperatively execute the AI task. Based on this, when the first network node determines that the second network node agrees to cooperatively execute the AI task, the first network node sends the processing result of the first task of the AI task and the target state information to the second network node.

For example, the first network node sends the second request information to the second network node. If the first network node receives a response to the second request information from the second network node, and the response to the second request information indicates that the second network node agrees to cooperatively execute the AI task, the first network node sends the processing result of the first task of the AI task and the target state information to the second network node.

For another example, the first network node sends the second request information to the second network node. If the first network node does not receive a negative acknowledgment from the second network node within a period of time (denoted as a time period #2 for differentiation), the first network node considers by default that the second network node agrees to cooperatively execute the AI task (equivalent to that the response information in an implicit form indicates that the second network node agrees to cooperatively execute the AI task). Therefore, the first network node sends the processing result of the first task of the AI task and the target state information to the second network node. For example, a start moment of the time period #2 may be a moment at which the first network node sends the second request information, and duration of the time period #2 may be predefined, or may be estimated based on a historical situation. This is not limited. In an example, the time period #2 may be implemented by using a timer.

Optionally, the method 400 further includes: The first network node further sends area information to the second network node. The area information is used by the second network node to determine a network node that cooperatively executes the AI task.

The area information is used to assist a current network node in determining another node that cooperatively executes the AI task. For example, the area information sent by the first network node to the second network node is used to assist the second network node in determining a network node that cooperatively executes the AI task.

In an example, the area information may include geographical location information, or the area information may be represented by some parameters (denoted as a parameter #A for differentiation). The parameter #A may be, for example, a service type, a terminal type, or a computing power type of a node. The service type may be a service type supported or run in a specific area. The terminal type may be a terminal type in a specific area. The node type may be a computing power type of a node in a specific area. Usually, parameters #A of nodes in a same area are close. During node selection, refer to a parameter #A in each area. In this way, a proper next node may be selected based on an actual requirement. For example, when selecting a next network node, the second network node may select a network node in an area with a large difference between parameters #A, or may select a network node in an area with a close difference between parameters #A.

Optionally, the network node schedules at least one terminal to participate in an operation of the network node. In other words, the at least one terminal and the network node jointly cooperatively execute the AI task. In this way, the at least one terminal is used to cooperatively execute the AI task, to reduce overheads caused by executing the AI task by the network node. For details, refer to related descriptions in the method 300. The details are not described herein again. Further, optionally, the network node determines, based on an AI state of the terminal, whether the terminal participates in execution of the AI task. Specifically, detailed descriptions are provided below with reference to a method 500.

It may be understood that the method 400 is mainly described by using an example in which a plurality of network nodes cooperatively execute the AI task. This is not limited. In an example, the network node may alternatively cooperate with the terminal to execute the AI task. For example, the first network node sends the processing result of the first task of the AI task and the target state information to the at least one terminal. In another example, the network node may alternatively cooperate with the core network node to execute the AI task. For example, the first network node sends the processing result of the first task of the AI task and the target state information to at least one core network node.

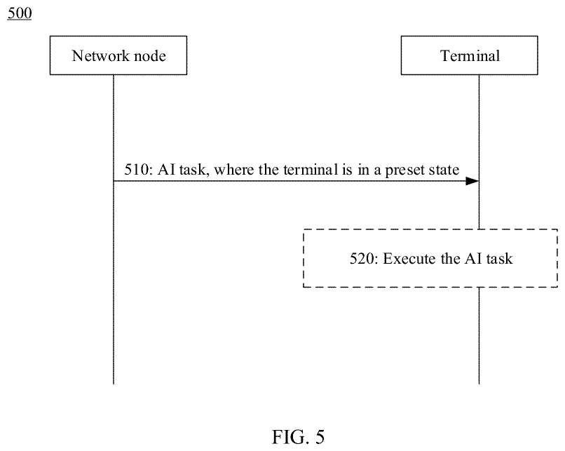

In an example, FIG. 5 is a diagram of an AI task indication method 500 according to another embodiment of the present disclosure. The method 500 may include the following steps.

510: A network node sends an AI task to a terminal, where the terminal is in a preset state. Optionally, the method 500 further includes step 520.

520: The terminal executes the AI task.

Based on this, different states (the states are denoted as AI states for differentiation) are defined for the terminal, so that the network node can learn, based on a state of the terminal, of whether the terminal can participate in execution of the AI task. For example, the network node may send the AI task to the terminal in the preset state. In other words, AI in the preset state may participate in execution of the AI task.

Further, optionally, if the state of the terminal is not the preset state, the network node sends notification information to the terminal. The notification information indicates to adjust the terminal to the preset state. In other words, the notification information indicates to adjust the AI state of the terminal to the preset state. For example, the notification information may be any one or a combination of a plurality of items of the following: radio resource control signaling, MAC layer signaling, physical layer signaling, and AI paging. The radio resource control signaling includes, for example, RRC signaling, the MAC layer signaling includes, for example, a MAC CE, and the physical layer signaling includes, for example, DCI. The AI paging may be sent by the network node, and is used to trigger a specific terminal or a terminal in a specific AI state to perform transition of the AI state.

In an example, the AI state of the terminal may be any one of the following: an AI-idle state, an AI-active state, and an AI-temporary state. The preset state may be, for example, the AI-active state. Names of all AI states are merely examples, and the names the AI states do not limit the protection scope of this embodiment of the present disclosure.

(1) AI-idle state: The terminal does not establish a connection to the AI node, and has no AI model locally. If the terminal is in the AI-idle state, the terminal may perform operations such as AI paging monitoring, AI node selection, and AI connection establishment.

For example, if the terminal is in the AI-idle state, the network node may first trigger the terminal to transition to the AI-active state, and then schedule the terminal to participate in execution of the AI task. In an example, the network node triggers, by using signaling, for example, sending notification information to the terminal, the terminal to complete the transition of the AI state.

(2) AI-active state: The terminal establishes an AI connection to the AI node. If the terminal is in the AI-active state, the terminal may perform operations such as AI scheduling monitoring, execution of the AI task based on scheduling, and selection of the AI node.

For example, if the terminal is in the AI-active state, the network node may schedule the terminal to participate in execution of the AI task.

(3) AI-temporary state: The terminal does not establish an AI connection to the AI node, and is locally deployed with the AI model. If the terminal is in the AI-temporary state, the terminal may perform operations such as AI paging monitoring, AI node selection, and AI connection establishment.

For example, if the terminal is in the AI-temporary state, the network node may first trigger the terminal to transition to the AI-active state, and then schedule the terminal to participate in execution of the AI task. In an example, the network node triggers, by using signaling, for example, sending notification information to the terminal, the terminal to complete the transition of the AI state.

It may be understood that the foregoing is example descriptions and set no limitation thereto. For example, in step 510, the control node sends the AI task to the terminal.

It may be further understood that the foregoing descriptions about the AI state of the terminal are merely example descriptions, and set no limitation thereto. For example, in addition to the AI-idle state, the AI-active state, and the AI-temporary state, the AI state of the terminal may further include another AI state.

It may be further understood that the method 500 may be used independently or may be used in combination with the method 300 or the method 400. This is not limited herein.

For example, the method 500 may be used in combination with the method 300. For example, the first network node is used as an example. The first network node sends a first task or a part of the first task to at least one terminal, and a state of the at least one terminal is the preset state. Based on this, if the state of the terminal is the preset state, the first network node sends the first task or the part of the first task to the terminal, and the terminal cooperates with the first network node to execute the first task.

For another example, the method 500 may be used in combination with the method 400. For example, the first network node is used as an example. The first network node sends a first task or a part of the first task to at least one terminal, and a state of the at least one terminal is the preset state. Based on this, if the state of the terminal is the preset state, the first network node sends the first task or the part of the first task to the terminal, and the terminal cooperates with the first network node to execute the first task.

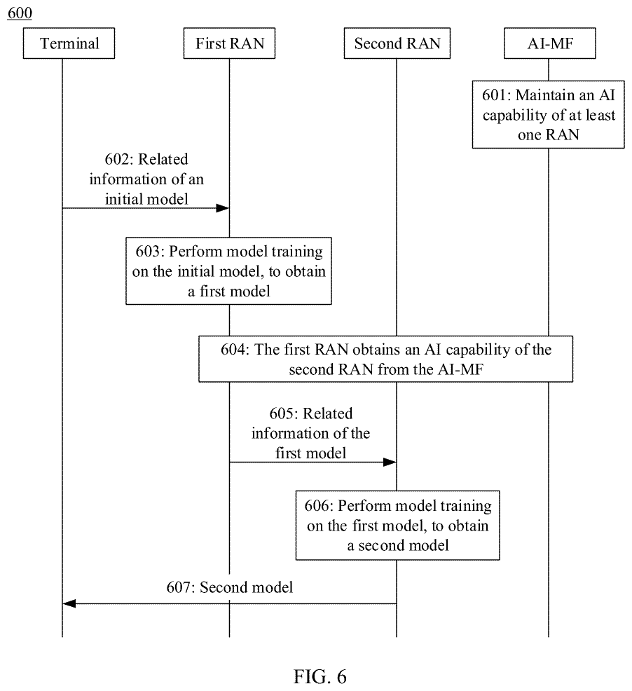

For ease of understanding, the following provides example descriptions of embodiments of the present disclosure with reference to FIG. 6 to FIG. 9 by using an example in which a network node is a RAN and a control node is an AI-MF. For details about related steps or terms, refer to the foregoing descriptions.

In an example, FIG. 6 is a schematic flowchart of an AI task indication method 600 according to an embodiment of the present disclosure. The method 600 may be used to implement the solution of the method 400. The method 600 may be applied to a scenario in which a terminal requests a RAN for an AI task related to a model. In an example, the method 600 may include the following steps.

601: An AI-MF maintains an AI capability of at least one RAN.

The AI capability of the RAN may include at least one of the following: a priority of the RAN, computing power supported by the RAN, a hardware capability of the RAN, an AI task supported by the RAN (or an operation type that can be performed by the RAN), performance of a local AI model of the RAN, and performance of a local dataset of the RAN. Further, optionally, if the AI capability of the RAN includes the AI task supported by the RAN, the AI capability of the RAN further includes a parameter associated with the AI task supported by the RAN.

For example, if the AI capability of the RAN includes the AI task supported by the RAN, and the AI task supported by the RAN includes model training, further optionally, the AI capability of the RAN includes a parameter associated with model training. In an example, the parameter associated with model training includes at least one of the following: a model structure, a training set, and available computing power.

For another example, if the AI capability of the RAN includes the AI task supported by the RAN, and the AI task supported by the RAN includes model fusion, further optionally, the AI capability of the RAN includes a parameter associated with model fusion. In an example, the parameter associated with model fusion includes at least one of the following: a model fusion policy, a model structure supporting fusion, and local knowledge base information.

For another example, if the AI capability of the RAN includes the AI task supported by the RAN, and the AI task supported by the RAN includes model testing, further optionally, the AI capability of the RAN includes a parameter associated with model testing. For example, the parameter associated with model testing includes at least one of the following: a model test capability and a test set.

For example, the AI capability of the RAN may exist, for example, stored or transmitted, in a form of a table, a function, or a character string. Table 3 shows an example of presenting the AI capability of the RAN in a form of a table.

TABLE 3

| | AI task | Performance of a local AI model of a RAN | | | | | |
|---|---|---|---|---|---|---|---|
| | supported | Task A | | | Task B | | |
| RAN | by a | Accu- | Time- | | Accu- | Time- | |
| identifier | RAN | racy | liness | . . . | racy | liness | . . . |
| RAN#1 | Task A | value1 | value2 | . . . | value1 | value2 | . . . |
| RAN#2 | Task A | value1 | value2 | | value1 | value2 | . . . |
| | and | | | | | | |
| | task B | | | | | | |

Table 3 is used as an example. For RAN #1, an AI task supported by RAN #1 includes the task A, and when a local model of RAN #1 executes the task A, accuracy is value1, and timeliness is value2. The accuracy may represent performance of the model when the model executes several tasks. The timeliness may represent generation time of the model.

In an example, an AI task supported by the RAN may be represented by using at least one bit. An AI task related to the model is used as an example. For example, it is assumed that the AI task related to the model includes a model training task, a model test task, and a model fusion task, and the AI task supported by the RAN is indicated by using two bits. If the bit is set to “00”, it indicates that the AI task supported by the RAN is the model training task. If the bit is set to “01”, it indicates that the AI task supported by the RAN is the model test task. If the bit is set to “10”, it indicates that the AI task supported by the RAN is the model fusion task. It should be understood that the foregoing is merely example descriptions and sets no limitation thereto.

In another example, the AI task supported by the RAN may be represented by using a bitmap. An AI task related to the model is used as an example. For example, it is assumed that the AI task related to the model includes a model training task, a model test task, and a model fusion task, and if a bit value is “1”, it indicates “support”, or if a bit value is “0”, it indicates “not support”. For example, if the AI task supported by the RAN is represented as “110”, three bits in “110” respectively correspond to the model training task, the model test task, and the model fusion task. Therefore, “110” indicates that the RAN supports the model training task and the model test task, and does not support the model fusion task. For example, if the AI task supported by the RAN is represented as “101”, three bits in “101” respectively correspond to the model training task, the model test task, and the model fusion task. Therefore, “101” indicates that the RAN supports the model training task and the model fusion task and does not support the model test task. It may be understood that the foregoing examples are example descriptions. This embodiment of the present disclosure is not limited thereto.

It may be understood that Table 3 shows merely example descriptions, and sets no limitation thereto. Any variation of Table 3 is applicable to the present disclosure. For example, Table 3 may further include more RANs. For another example, RAN #1 and RAN #2 in Table 3 support more AI tasks. For another example, Table 3 may further include more parameters representing the performance of the local AI model.

In this embodiment of the present disclosure, the AI task related to the model is mainly used as an example for example description. Therefore, the AI capability of the RAN mainly describes a capability related to the model. This is not limited herein.

In this embodiment of the present disclosure, it is assumed that the terminal releases the AI task to a first RAN, and the AI task released by the terminal to the first RAN is a model training task.

602: The terminal sends related information of an initial model to the first RAN.

For example, the terminal performs an encapsulation operation on the initial model and uses encapsulation to carry the related information of the initial model. Optionally, the terminal may further perform a segmentation operation on the initial model, so that the first RAN correctly restores the initial model.

The initial model is a model on which model training is to be performed.

The related information of the initial model may include at least one of the following: a parameter set of the initial model, current state information, target state information, area information, and a version of the initial model. The following briefly describes the foregoing information. For information that is not described in detail, refer to related descriptions in the method 400.

(1) The current state information may be used to describe a state of the model when the model is generated by a current node. In an example, the current state information includes at least one piece of the following information: accuracy and timeliness. For operations such as model compression and model distillation involving a model structure change, descriptions about the model structure of the model can be further added to the state information.

It may be understood that, for the initial model, the current state information may not be carried.

(2) The target state information or the target state information of the initial model may be used to describe a final state of the model or may be used to describe a state of the model when the model stops flowing in a network. In an example, the target state information includes at least one piece of the following information: accuracy and timeliness. For operations such as model compression and model distillation involving a model structure change, descriptions about the model structure of the model can be further added to the state information.

(3) The area information is used to assist the current node in determining another node that cooperatively executes the model training task. For example, the area information in the related information of the initial model may be used to assist the first RAN node in determining the RAN that cooperatively performs the model training task.

(4) The parameter set of the initial model may include a training weight of a neural network corresponding to the initial model.

(5) The version of the initial model is, for example, denoted as t1, indicates that t1 times of model training are performed for the initial model provided by the terminal, and t1 is an integer greater than 0 or equal to 0. For example, if the version of the initial model is 0, it indicates that model training is not performed for the initial model provided by the terminal. For another example, if the version of the initial model is 1, it indicates that one time of model training is performed for the initial model provided by the terminal (for example, the terminal has performed one time of model training).

It may be understood that the foregoing information is example descriptions and set no limitation thereto. For example, the related information of the initial model may further include a structure of the neural network corresponding to the initial model, an operation rule of an initial model parameter, a number of the initial model, and the like.

Step 602 may include the following implementations.

In a possible implementation, in step 602, the terminal sends the related information of the initial model to the first RAN. The related information of the initial model may implicitly indicate that the first RAN needs to perform model training on the initial model. For example, the related information of the initial model includes the current state information and the target state information, and the first RAN determines, based on inconsistency between the current state information and the target state information, to perform model training on the initial model.

In another possible implementation, in step 602, the terminal sends indication information and the related information of the initial model to the first RAN. The indication information indicates to perform model training on the initial model.

603: The first RAN performs model training on the initial model, to obtain a first model.

The first RAN may execute the model training task based on the initial model provided by the terminal in step 602. For differentiation, a model obtained after the first RAN performs model training on the initial model is denoted as the first model.

In this embodiment of the present disclosure, it is assumed that the first RAN cannot independently complete the model training task. In other words, a state of the first model obtained by performing model training on the initial model by the first RAN does not meet a target state required by the terminal. Therefore, the first RAN may complete the model training task through cooperation with another RAN. It is assumed that a RAN that is determined by the first RAN and that is used to cooperatively execute the model training task is a second RAN.

Optionally, the first RAN may further schedule a terminal in a cell of the first RAN to participate in an operation, for example, participate in performing model training on the initial model. For a detailed implementation, refer to related descriptions in the method 500. The details are not described herein again.

604: The first RAN obtains an AI capability of the second RAN from the AI-MF.

It is assumed that the at least one RAN in step 601 includes the second RAN. In other words, the AI-MF maintains the AI capability of the second RAN. The first RAN may obtain the AI capability of the second RAN from the AI-MF.

For the first RAN and the second RAN, refer to descriptions of a first network node and a second network node in the method 400. Details are not described herein again.

For that the first RAN obtains the AI capability of the second RAN from the AI-MF, refer to descriptions that the first network node obtains an AI capability of the second network node from a control node in the method 400. Details are not described herein again.

It may be understood that in this embodiment of the present disclosure, one second RAN is mainly used as an example for description, and a quantity of second RANs is not limited. For example, the first RAN may obtain an AI capability of at least one second RAN from the AI-MF.

It may be further understood that step 604 is example descriptions. This embodiment of the present disclosure is not limited thereto. For example, the first RAN may also obtain the AI capability of the second RAN from the second RAN. For details, refer to descriptions that the first network node obtains the AI capability of the second network node from the second network node in the method 400. Details are not described herein again.

605: The first RAN sends related information of the first model to the second RAN.

For example, the first RAN may perform an encapsulation operation on the first model and use an encapsulation to carry the related information of the first model. Optionally, the first RAN may further perform a segmentation operation on the first model, so that the second RAN correctly restores the first model.

The first model is a model obtained after the first RAN performs model training.

The related information of the first model may include at least one of the following: a parameter set of the first model, current state information, target state information, area information, and a version of the first model. The following briefly describes the current state information, the area information, and the version of the first model. For other information that is not described in detail, refer to related descriptions in step 602.

(1) Current state information: As described above, the current state information is used to describe a state of the model when the model is generated by a current node. Therefore, the current state information provided by the first RAN to the second RAN herein indicates the current state information of the first model, and is used to describe a state of the first model when the first model is generated by the first RAN.

(2) Area information: As described above, the area information is used to assist the current node in determining another node that cooperatively executes the model training task. Therefore, the area information in the related information of the first model herein may be used to assist the second RAN in determining the RAN that cooperatively executes the model training task.

The area information in the related information of the first model may be the same as or different from the area information in the related information of the initial model in step 602.

For example, the area information in the related information of the first model and the area information in the related information of the initial model are the same, for example, each are area information in which the terminal can receive a signal.

For another example, the area information in the related information of the first model is different from the area information in the related information of the initial model. The area information in the related information of the first model is information about a coverage area of a low frequency base station, and the area information in the related information of the initial model is information about a coverage area of a high frequency base station.

(3) The version of the first model, for example, denoted as t2, indicates that t2 times of model training are performed for the first model provided by the first RAN, and t2 is an integer greater than 1 or equal to 1. For example, if the version of the first model is 1, it indicates that one time of model training is performed for the first model provided by the first RAN. In other words, the first model is a model obtained after one time of model training is performed on the initial model, or the first RAN is a RAN that performs model training on the initial model for a first time.

The first RAN may send the related information of the first model to the second RAN in the following two manners:

In a possible implementation, when the first RAN determines that the second RAN can execute the model training task, the first RAN sends the related information of the first model to the second RAN. For example, the first RAN determines, based on the AI capability that is of the second RAN and that is obtained in step 604, that the second RAN can execute the model training task. For example, the AI capability of the second RAN includes the AI task supported by the second RAN, and the AI task supported by the second RAN includes the model training task. Therefore, the first RAN sends the related information of the first model to the second RAN.

In another possible implementation, after performing model training on the initial model, the first RAN directly sends the related information of the first model to the second RAN. For example, the first RAN may consider by default that or assume that the second RAN may execute the model training task. Therefore, after performing model training on the initial model, the first RAN directly sends the related information of the first model to the second RAN.

Optionally, that the first RAN sends related information of the first model to the second RAN includes: When the first RAN determines that the second RAN agrees to cooperatively execute the model training task, the first RAN sends the related information of the first model to the second RAN.

For example, before step 605, the method 600 further includes: The first RAN requests the second RAN to execute the model training task. After the second RAN determines, namely, agrees to cooperate with the first RAN to execute the model training task, the first RAN sends the related information of the first model to the second RAN.

606: The second RAN performs model training on the first model, to obtain a second model. The second RAN may execute the model training task based on the first model generated by the first RAN. For differentiation, a model obtained after the second RAN performs model training on the first model is denoted as the second model.

In a first possible case, after the second RAN executes the model training task, if the model reaches the target state, in other words, a state of the second model meets the target state. In this case, the method 600 further includes step 607.

In a second possible case, after the second RAN executes the model training task, if the model does not reach the target state, in other words, the state of the second model does not meet the target state, the second RAN may obtain an AI capability of a third RAN and send related information of the second model to the third RAN. For details, refer to step 604 and step 605. Details are not described herein again. This is repeatedly performed, until the model reaches the target state, and a finally generated model is sent to the terminal.

Optionally, the second RAN may further schedule a terminal in a cell of the second RAN to participate in an operation, for example, participate in performing model training on the first model. For a detailed implementation, refer to related descriptions in the method 500. The details are not described herein again.

607: The second RAN sends the second model to the terminal.

It is assumed that after the second RAN executes the model training task, the model reaches the target state, in other words, the state of the second model meets the target state. In a possible implementation, the second RAN sends the second model to the terminal. Alternatively, in another possible implementation, the second RAN sends the second model to the first RAN, and the first RAN forwards the second model to the terminal. This is not limited.

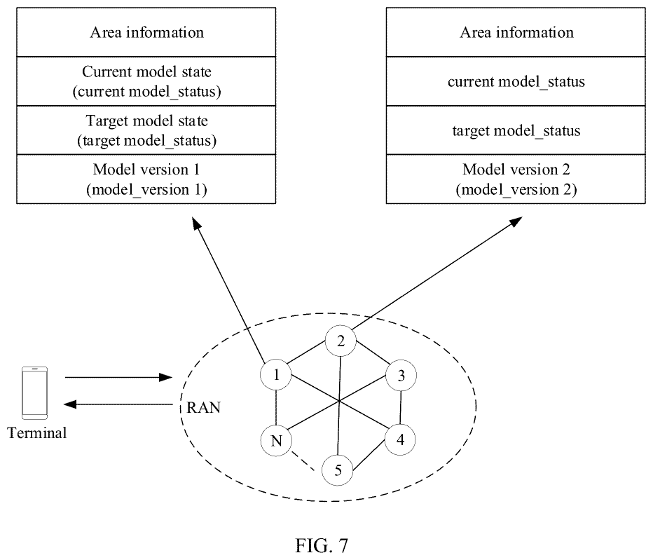

In an example, FIG. 7 is a diagram applicable to an embodiment of the present disclosure. As shown in FIG. 7, a number i (i=1, 2, 3, 4, 5, . . . , N) represents a different RAN, and N is an integer greater than 1.

For example, the terminal sends the related information of the initial model to the first RAN (for example, a RAN with a number 1); the first RAN performs model training on the initial model, to obtain the first model, and sends the related information of the first model to the second RAN (for example, a RAN with a number 2), for example, including: the area information, the current model state (namely, state description information of the first model), a target model state (namely, the target state information), and a model version 1; the second RAN performs model training on the first model, to obtain the second model, and sends the related information of the second model to the third RAN (for example, a RAN with a number 3), for example, including: the area information, the current model state (namely, state description information of the second model), a target model state (namely, the target state information), and a model version 2; and so on, until the current model state reaches the target model state. The model version 1 indicates that a model provided by the first RAN is a model obtained by performing model training on the initial model for a first time. In other words, the first RAN is a RAN that performs model training on the initial model for a first time. The model version 2 indicates that a model provided by the second RAN is a model obtained by performing model training on the initial model for a second time. In other words, the second RAN is a RAN that performs model training on the initial model for a second time.

It may be understood that example descriptions of the method 600 are mainly provided by using the model training task as an example. It may be understood that the model training task may be replaced with any other task related to the model.

It can be further understood that the foregoing steps are merely example descriptions. This is not strictly limited. In addition, sequence numbers of the foregoing processes do not mean a sequence of execution. The sequence of execution of the processes should be determined based on functions and internal logic of the processes and should not constitute any limitation on an implementation process of this embodiment of the present disclosure. For example, there is no strict sequence between step 604 and step 602. For example, step 604 may be performed before step 602; or step 602 may be performed before step 604; or step 604 and step 602 may be performed synchronously. This is not limited herein.

It may be further understood that the foregoing mainly provides example descriptions by using an example in which one RAN determines a next cooperative RAN. This is not limited herein. For example, one RAN may determine a plurality of cooperative RANs, and the plurality of cooperative RANs cooperatively execute the AI task.

The foregoing describes, with reference to FIG. 6, an example of a scenario in which the terminal requests the RAN for the AI task related to the model. Based on the foregoing embodiment, the plurality of RANs may cooperatively complete the AI task requested by the terminal. In addition, each RAN may cooperatively perform the AI task based on related information that is of the model and that is received from a previous RAN.

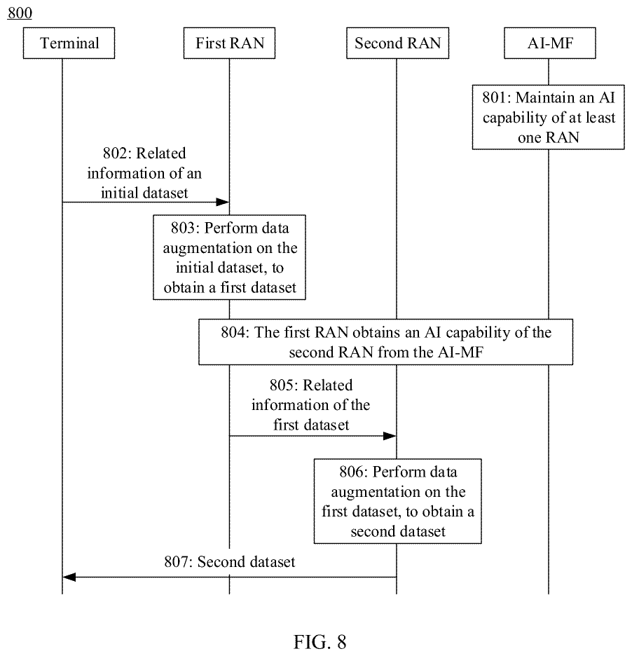

In an example, FIG. 8 is a schematic flowchart of an AI task indication method 800 according to another embodiment of the present disclosure. The method 800 may be used to implement the solution of the method 400. The method 800 may be applied to a scenario in which a terminal requests a RAN for an AI task related to a dataset. In an example, the method 800 may include the following steps.

801: An AI-MF maintains an AI capability of at least one RAN.

The AI capability of the RAN may include at least one of the following: a priority of the RAN, computing power supported by the RAN, a hardware capability of the RAN, an AI task supported by the RAN (or an operation type that can be performed by the RAN), performance of a local AI model of the RAN, and performance of a local dataset of the RAN. Further, optionally, if the AI capability of the RAN includes the AI task supported by the RAN, the AI capability of the RAN further includes a parameter associated with the AI task supported by the RAN.

For another example, if the AI capability of the RAN includes the AI task supported by the RAN, and the AI task supported by the RAN includes a data cleaning operation, further optionally, the AI capability of the RAN includes a parameter associated with the data cleaning operation. For example, the parameter associated with the data cleaning operation includes at least one of the following: a data supplement to a specific attribute, redundancy identification, authenticity verification, and the like.

For another example, if the AI capability of the RAN includes the AI task supported by the RAN, and the AI task supported by the RAN includes a data augmentation operation, further optionally, the AI capability of the RAN includes a parameter associated with the data augmentation operation. In an example, the parameter associated with the data augmentation operation includes a supported augmentation policy, for example, data augmentation on a single data source (single sample augmentation, multi-sample augmentation, generative adversarial network (GAN) generation, automatic augmentation, and the like), and data integration on a plurality of data sources.

For another example, if the AI capability of the RAN includes the AI task supported by the RAN, and the AI task supported by the RAN includes a data reduction operation, further optionally, the AI capability of the RAN includes a parameter of the data reduction operation. In an example, a parameter associated with the data reduction operation includes a used reduction policy, for example, includes dimension reduction, dimension transformation, or the like for a specific task.

For example, the AI capability of the RAN may exist, for example, stored or transmitted, in a form of a table, a function, or a character string. Table 4 shows an example of presenting the AI capability of the RAN in a form of a table.

TABLE 4

| | AI task | Performance of a local dataset of a RAN | | | | | |
|---|---|---|---|---|---|---|---|
| | supported | Task A | | | Task B | | |
| RAN | by a | Accu- | Time- | | Accu- | Time- | |
| identifier | RAN | racy | liness | . . . | racy | liness | . . . |
| RAN#1 | Task A | value1 | value2 | . . . | value1 | value2 | . . . |
| RAN#2 | Task A | value1 | value2 | . . . | value1 | value2 | . . . |
| | and | | | | | | |
| | task B | | | | | | |

It may be understood that a difference between Table 4 and Table 3 lies in that Table 3 is mainly described by using an AI task related to a model as an example, and Table 4 is mainly described by using an AI task related to a dataset as an example.

Table 4 is used as an example. For RAN #1, an AI task supported by RAN #1 includes the task A, the accuracy of the task A is value1, and the timeliness is value2. The accuracy may represent performance of the dataset in a test model, and the timeliness may represent generation time of the dataset.

In an example, the AI task supported by the RAN may be represented by using at least one bit. The AI task related to the dataset is used as an example. For example, it is assumed that the AI task related to the dataset includes data cleaning, data augmentation, data reduction, and data conversion, and the AI task supported by the RAN is indicated by using two bits. If the bit is set to “00”, it indicates that the AI task supported by the RAN is data cleaning; if the bit is set to “01”, it indicates that the AI task supported by the RAN is data augmentation; if the bit is set to “10”, it indicates that the AI task supported by the RAN is data reduction; or if the bit is set to “11”, it indicates that the AI task supported by the RAN is data conversion. It should be understood that the foregoing is merely example descriptions and sets no limitation thereto.

In another example, the AI task supported by the RAN may be represented by using a bitmap. The AI task related to the dataset is used as an example. For example, it is assumed that the AI task related to the dataset includes data cleaning, data augmentation, data reduction, and data conversion, and if a bit value is “1”, it indicates “support”, or if a bit value is “0”, it indicates “not support”. For example, if the AI task supported by the RAN is represented as “0110”, and four bits in “0110” respectively correspond to data cleaning, data augmentation, data reduction, and data conversion, “0110” indicates that the RAN supports data augmentation and data reduction, and does not support data cleaning or data conversion. For another example, if the AI task supported by the RAN is represented as “1011”, and four bits in “1011” respectively correspond to data cleaning, data augmentation, data reduction, and data conversion, “1011” indicates that the RAN supports data cleaning, data reduction, and data conversion, and does not support data augmentation. It may be understood that the foregoing examples are example descriptions. This embodiment of the present disclosure is not limited thereto.

It may be understood that Table 4 shows merely example descriptions and sets no limitation thereto. Any variation of Table 4 is applicable to the present disclosure. For example, Table 4 may further include more RANs. For another example, in Table 4, RAN #1 and RAN #2 support different AI tasks, or RAN #1 and RAN #2 support more AI tasks. For another example, Table 4 may further include more parameters representing the performance of the local dataset.

In this embodiment of the present disclosure, the AI task related to the dataset is mainly used as an example for example description. Therefore, the AI capability of the RAN mainly describes a capability related to the dataset. This is not limited herein.

In this embodiment of the present disclosure, it is assumed that the terminal releases the AI task to a first RAN, and the AI task released by the terminal to the first RAN is data augmentation. 802: The terminal sends related information of an initial dataset to the first RAN. The initial dataset is a dataset of a to-be-executed data augmentation task.

The related information of the initial dataset may include at least one of the following: current state information, target state information, area information, and a version of the initial dataset. The following briefly describes the foregoing information.

(1) The current state information may be used to describe a state of the dataset when the dataset is generated by a current node. For example, the current state information may include at least one piece of the following information: accuracy, timeliness, a component, and an attribute. The accuracy may represent performance of the dataset in several test models. The timeliness may represent generation time of the dataset. The component may represent a component of data included in the dataset. The attribute can represent a type, quantization, a dimension, and the like of the data included in the dataset.

It may be understood that, for the initial dataset, the current state information may not be carried.

(2) The target state information or the target state information of the initial dataset may be used to describe a final state of the dataset or may be used to describe a state of the dataset when the dataset stops flowing in a network. In an example, the target state information includes at least one piece of the following information: accuracy, timeliness, a component, and an attribute. For each piece of information, refer to the foregoing descriptions. Details are not described herein again.

(3) The area information is used to assist the current node in determining another node that cooperatively executes a dataset augmentation task. For example, the area information in the related information of the initial dataset may be used to assist the first RAN node in determining the RAN that cooperatively executes the data augmentation task.

(4) The version of the initial dataset is, for example, denoted as t1, indicates that t1 times of dataset augmentation are performed for the initial dataset provided by the terminal, and t1 is an integer greater than 0 or equal to 0. For details, refer to related descriptions of the version of the model in the method 600. Details are not described herein again.

It may be understood that the foregoing information is example descriptions, and set no limitation thereto.

Step 802 may include the following implementations.

In a possible implementation, in step 802, the terminal sends the related information of the initial dataset to the first RAN. The related information of the initial dataset may implicitly indicate that the first RAN needs to perform a dataset augmentation operation on the initial dataset. For example, the related information of the initial dataset includes the current state information and the target state information, and the first RAN determines, based on inconsistency between the current state information and the target state information, to perform the dataset augmentation operation on the initial dataset.

In another possible implementation, in step 802, the terminal sends indication information and the related information of the initial dataset to the first RAN. The indication information indicates to perform dataset augmentation on the initial dataset.

803: The first RAN performs data augmentation on the initial dataset, to obtain a first dataset.

The first RAN may execute the data augmentation task based on the initial dataset provided by the terminal in step 602. For differentiation, a dataset obtained by performing data augmentation on the initial dataset by the first RAN is denoted as the first dataset.

In this embodiment of the present disclosure, it is assumed that the first RAN cannot independently complete the data augmentation task. To be specific, a state of the first dataset obtained by performing data augmentation on the initial dataset by the first RAN does not meet a target state required by the terminal. Therefore, the first RAN may complete the data augmentation task through cooperation with another RAN. It is assumed that a RAN that is determined by the first RAN and that is used to cooperatively execute the data augmentation task is a second RAN.

Optionally, the first RAN may further schedule a terminal in a cell of the first RAN to participate in an operation, for example, participate in data augmentation on the initial dataset. For a detailed implementation, refer to related descriptions in the method 500. The details are not described herein again.

804: The first RAN obtains an AI capability of the second RAN from the AI-MF.

It is assumed that the at least one RAN in step 601 includes the second RAN. In other words, the AI-MF maintains the AI capability of the second RAN. The first RAN may obtain the AI capability of the second RAN from the AI-MF.

For the first RAN, the second RAN, and a manner in which the first RAN obtains the AI capability of the second RAN from the AI-MF, refer to related descriptions in step 601. Details are not described herein again.

805: The first RAN sends related information of the first dataset to the second RAN.

The first dataset is a dataset obtained after the first RAN performs dataset augmentation.

The related information of the first dataset may include at least one of the following: current state information, target state information, area information, and a version of the first dataset. The following briefly describes the current state information, the area information, and the version of the first model. For other information that is not described in detail, refer to related descriptions in step 802.

(1) Current state information: As described above, the current state information is used to describe a state of the dataset when the dataset is generated by a current node. Therefore, the current state information provided by the first RAN to the second RAN herein indicates the current state information of the first dataset and is used to describe a state of the first dataset when the first dataset is generated by the first RAN.

(2) Area information: As described above, the area information is used to assist the current node in determining another node that cooperatively executes the data augmentation task. Therefore, the area information in the related information of the first dataset may be used to assist the second RAN in determining the RAN that cooperatively executes the data augmentation task. For the area information, refer to the area information in step 605. Details are not described herein again.

(3) The version of the first dataset is, for example, denoted as t2, indicates that t2 times of data augmentation are performed for the first dataset provided by the first RAN, and t2 is an integer greater than 1 or equal to 1. For example, if the version of the first dataset is 1, it indicates that one time of data augmentation is performed for the first dataset provided by the first RAN. In other words, the first dataset is a dataset obtained after one time of data augmentation is performed on the initial dataset, or the first RAN is a RAN that performs data augmentation on the initial dataset for a first time.

For a related solution in which the first RAN sends the related information of the first model to the second RAN, refer to the descriptions in step 605. Details are not described herein again.

806: The second RAN performs data augmentation on the first dataset, to obtain a second dataset.

The second RAN may execute the data augmentation task based on the first dataset generated by the first RAN. For differentiation, a dataset obtained by performing data augmentation on the first dataset by the second RAN is denoted as a second dataset.

In a first possible case, after the second RAN executes the data augmentation task, the dataset reaches the target state. In other words, a state of the second dataset meets the target state. In this case, the method 800 further includes step 807.

In a second possible case, after the second RAN executes the data augmentation task, if the dataset does not reach the target state, in other words, a state of the second dataset does not meet the target state, the second RAN may obtain an AI capability of a third RAN and send related information of the second dataset to the third RAN. For details, refer to step 804 and step 805. Details are not described herein again. This is repeatedly performed, until the dataset reaches the target state, and a finally generated dataset is sent to the terminal.

Optionally, the second RAN may further schedule a terminal in a cell of the second RAN to participate in an operation, for example, participate in performing data augmentation on the first dataset. For a detailed implementation, refer to related descriptions in the method 500. The details are not described herein again.

807: The second RAN sends the second dataset to the terminal.

It is assumed that after the second RAN executes the data augmentation task, the dataset reaches the target state, in other words, the state of the second dataset meets the target state. In a possible implementation, the second RAN sends the second dataset to the terminal. Alternatively, in another possible implementation, the second RAN sends the second dataset to the first RAN, and the first RAN forwards the second dataset to the terminal. This is not limited.

It may be understood that example descriptions of the method 800 are mainly provided by using a task related to a dataset as an example. It may be understood that the foregoing data augmentation task may be replaced with any other task related to the dataset.

It can be further understood that the foregoing steps are merely example descriptions. This is not strictly limited. In addition, sequence numbers of the foregoing processes do not mean a sequence of execution. The sequence of execution of the processes should be determined based on functions and internal logic of the processes and should not constitute any limitation on an implementation process of this embodiment of the present disclosure. For example, there is no strict sequence between step 804 and step 802. For example, step 804 may be performed before step 802; or step 802 may be performed before step 804; or step 804 and step 802 may be performed synchronously. This is not limited herein.

It may be further understood that the foregoing mainly provides example descriptions by using an example in which one RAN determines a next cooperative RAN. This is not limited herein. For example, one RAN may determine a plurality of cooperative RANs, and the plurality of cooperative RANs cooperatively execute the AI task.

The foregoing describes, with reference to FIG. 8, an example of a scenario in which the terminal requests the RAN for the AI task related to the dataset. Based on the foregoing embodiment, the plurality of RANs may cooperatively complete the AI task requested by the terminal. In addition, each RAN may cooperatively perform the AI task based on related information that is of the dataset and that is received from a previous RAN.

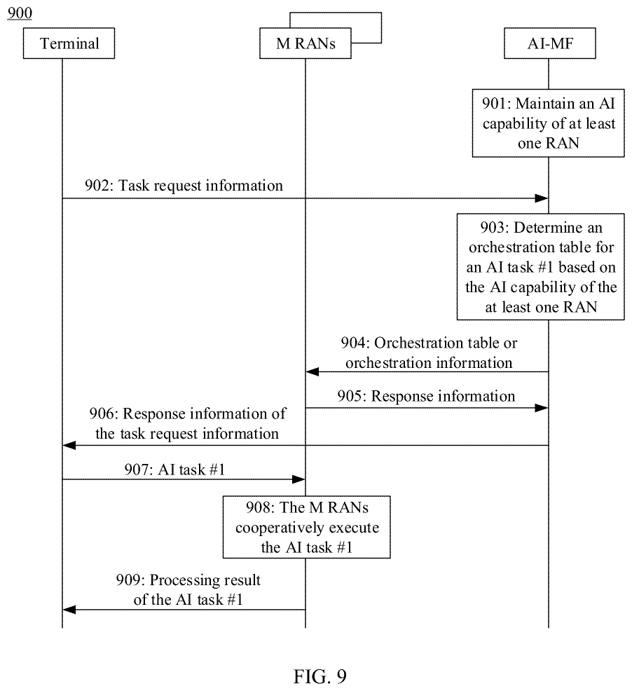

In an example, FIG. 9 is a schematic flowchart of an AI task indication method 900 according to another embodiment of the present disclosure. The method 900 may be used to implement the solution of the method 300. The method 900 may be applied to a scenario in which a terminal initiates an AI task request. In an example, the method 900 may include the following steps.

901: An AI-MF maintains an AI capability of at least one RAN.

For step 901, refer to the descriptions in step 601 or step 801. Details are not described herein again.

902: The terminal sends task request information to the AI-MF.

The task request information is used to request to execute an AI task, in other words, is used to request the AI-MF to determine orchestration information for executing the AI task. For differentiation, the AI task that the terminal requests to execute is denoted as an AI task #1.

For example, the AI task #1 may include, for example, an AI task related to a model and an AI task related to a dataset.

In a possible implementation, before the terminal sends the task request information to the AI-MF, the terminal establishes a connection to the AI-MF, and the terminal sends the task request information to the AI-MF based on the connection established to the AI-MF. In another possible implementation, the terminal sends the task request information to the AI-MF by using another device (for example, a RAN).

903: The AI-MF determines an orchestration table for the AI task #1 based on the AI capability of the at least one RAN.

After receiving the task request information from the terminal, the AI-MF may determine the orchestration table for the AI task #1 based on the AI capability of the at least one RAN.

The orchestration table includes orchestration information of N RANs. N is an integer greater than 1 or equal to 1. In other words, in step 903, the AI-MF determines the orchestration information of the N RANs for the AI task #1 based on the AI capability of the at least one RAN.

For the orchestration table, the orchestration information, and a solution in which the AI-MF determines the orchestration table for the AI task #1 based on the AI capability of the at least one RAN, refer to related descriptions in the method 300. Details are not described herein again.

904: The AI-MF sends the orchestration table or the orchestration information to at least one of the N RANs.

That the AI-MF sends the orchestration table or the orchestration information to the at least one of the N RANs may include the following implementations.

In a first possible implementation, the AI-MF sends the orchestration table to each of the N RANs.

In a second possible implementation, the AI-MF sends the orchestration table to one of the N RANS.

In a third possible implementation, the AI-MF sends orchestration information of each of the N RANs to each RAN.

For the three implementations, refer to a transmission manner of orchestration information of each network node in the method 300. Details are not described herein again.

905: The at least one of the N RANs sends response information to the AI-MF.

The response information may be used to notify the AI-MF that the orchestration information or the orchestration table is successfully received or may be used to notify the AI-MF whether to agree with the orchestration information or the orchestration table.

In a possible implementation, if in step 904, the AI-MF sends the orchestration table to each of the N RANs, or the AI-MF sends the orchestration information of each of the N RANs to each RAN, the N RANs each send response information to the AI-MF in step 905.

In another possible implementation, if the AI-MF sends the orchestration table to one (for example, denoted as a first RAN) of the N RANs in step 904, the first RAN sends response information to the AI-MF in step 905.

For a specific implementation of the response information, refer to related descriptions in the method 300. Details are not described herein again.

The method 900 is mainly described by using an example in which each RAN agrees with orchestration information of the RAN. For a solution in which the RAN disagrees with the orchestration information, refer to related descriptions in the method 300.

906: The AI-MF sends response information of the task request information to the terminal. The response information of the task request information may be used to notify the terminal that the orchestration table is determined for the AI task #1 requested by the terminal. In this way, the terminal may provide an initial model or an initial dataset for a RAN participating in execution of the AI task #1. It may be understood that if the AI-MF determines that the orchestration table fails, for example, none of the RANs supports the AI task #1 in the AI capability that is of the at least one RAN and that is maintained by the AI-MF in step 901, the AI-MF may also send the response information of the task request information to the terminal. The response information of the task request information is used to notify the terminal that the orchestration table cannot be provided for the AI task #1 requested by the terminal.

In a possible implementation, after receiving a response to the orchestration information, the AI-MF sends a response to the task request information to the terminal. In another possible implementation, after determining the orchestration table for the AI task #1, the AI-MF sends a response to the task request information to the terminal.

907: The terminal sends the AI task #1 to the N RANs.

In a possible implementation, the terminal sends the AI task #1 to the 1st RAN in the N RANs. The 1st RAN indicates a RAN that is in the N RANs and that first executes the AI task #1.

For example, if the AI task #1 is a model training task, the terminal sends the initial model to the 1st RAN in the N RANs.

For another example, if the AI task #1 is a dataset collection task, the terminal sends, to the 1st RAN in the N RANs, an attribute of a dataset that needs to be collected.

908: The N RANs cooperatively execute the AI task #1.

A manner of cooperatively executing the AI task includes: continuing to execute the AI task based on a result of executing the AI task by a previous RAN, or simultaneously executing, by all the RANs, a task for which each RAN is responsible.

Optionally, the RAN may further schedule a terminal in a cell of the RAN to participate in an operation. For a detailed implementation, refer to related descriptions in the method 500. The details are not described herein again.

909: The RAN sends a processing result of the AI task #1 to the terminal.

The RAN in step 909 may be any one of the N RANs. For example, the RAN in step 909 may be a last RAN participating in execution of the AI task #1, or may be the 1st RAN participating in execution of the AI task #1. This is not limited herein.

It can be understood that the foregoing steps are merely example descriptions. This is not strictly limited. In addition, sequence numbers of the foregoing processes do not mean a sequence of execution. The sequence of execution of the processes should be determined based on functions and internal logic of the processes and should not constitute any limitation on an implementation process of this embodiment of the present disclosure.

With reference to FIG. 9, the foregoing describes an example of a scenario in which the control node AI-MF determines the orchestration table for the AI task. Based on the foregoing embodiment, the control node determines an operation that each network node RAN executes the AI task, to provide global efficiency.

It may be understood that, in the foregoing embodiment, when a plurality of RANs execute a specific AI task, each RAN may execute a part of the AI task, to jointly complete the AI task.

It may be further understood that in the foregoing embodiment, an example in which the plurality of RANs sequentially execute an AI task requested by a terminal is mainly used for example descriptions. This is not limited herein. For example, the AI-MF determines a task for which each RAM is responsible, and each RAN may simultaneously or synchronously execute a task for which each RAN is responsible.

It may be further understood that naming of some message or information names in embodiments of the present disclosure does not limit the protection scope of embodiments of the present disclosure. An example in which A sends a message to B is used, and any message that can be used between A and B is applicable to embodiments of the present disclosure.

It may be further understood that, in some of the foregoing embodiments, sending a message is mentioned for a plurality of times. For example, A sends a message to B. That A sends a message to B may include that A directly sends a message to B or may include that A sends a message to B via another apparatus. This is not limited.

It may be further understood that some optional features in embodiments of the present disclosure may not depend on another feature in some scenarios, or may be combined with another feature in some scenarios. This is not limited.

It may be further understood that the solutions in embodiments of the present disclosure may be appropriately combined for use, and explanations or descriptions of terms in the embodiments may be mutually referenced or explained in the embodiments. This is not limited.

It may be further understood that, in the foregoing method embodiments, methods and operations implemented by a device (for example, a terminal, a control node, or a network node) may also be implemented by a component (for example, a chip or a circuit) of the device.

Corresponding to the methods provided in the foregoing method embodiments, an embodiment of the present disclosure further provides a corresponding apparatus. The apparatus includes a corresponding module configured to perform the foregoing method embodiments. The module may be software, hardware, or a combination of software and hardware. It may be understood that the technical features described in the method embodiments are also applicable to the following apparatus embodiments.

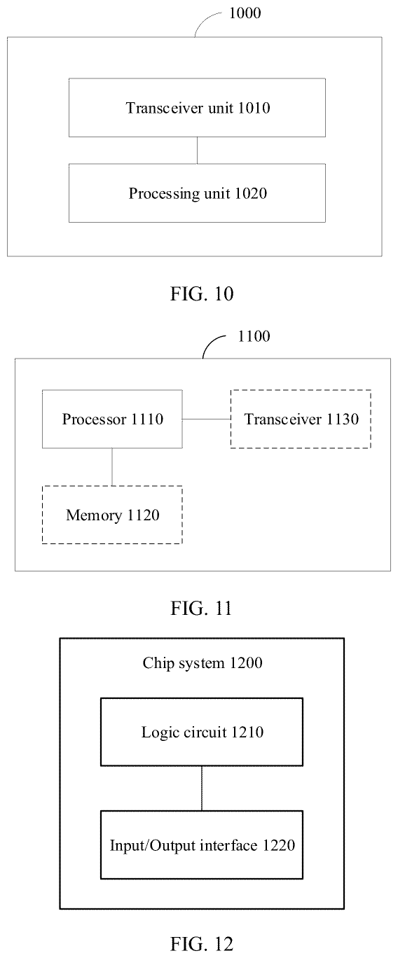

In an example, FIG. 10 is a schematic block diagram of a communication apparatus 1000 according to an embodiment of the present disclosure. The apparatus 1000 includes a transceiver unit 1010 and a processing unit 1020. The transceiver unit 1010 may be configured to implement a corresponding communication function. The transceiver unit 1010 may also be referred to as a communication interface or a communication unit. The processing unit 1020 may be configured to implement a corresponding processing function, for example, determining orchestration information, or executing an AI task.

In a design, the apparatus 1000 is configured to perform steps or procedures performed by the control node in the embodiment shown in FIG. 3, and steps or procedures performed by the AI-MF in the embodiment shown in FIG. 9.

In a possible implementation, the processing unit 1020 is configured to determine first orchestration information for an AI task. The first orchestration information indicates a first network node to execute a first task of the AI task. The transceiver unit 1010 is configured to send the first orchestration information to the first network node.

In an example, the processing unit 1020 is further configured to determine second orchestration information for the AI task. The second orchestration information indicates a second network node to execute a second task of the AI task. The transceiver unit 1010 is further configured to: send the second orchestration information to the first network node, or send the second orchestration information to the second network node.

In another example, the processing unit 1020 is further configured to determine second orchestration information for the AI task. The second orchestration information indicates a second network node to execute a second task of the AI task. The transceiver unit 1010 is further configured to send the first orchestration information and the second orchestration information to the second network node. That the transceiver unit 1010 is configured to send the first orchestration information to the first network node includes: The transceiver unit 1010 is configured to send the first orchestration information and the second orchestration information to the first network node.

In another example, the first network node is the 1st network node participating in execution of the AI task.

In another example, the first orchestration information includes at least one piece of the following information: the first task, an identifier of the first network node, a resource provided for executing the first task by the first network node, or an exit condition of executing the first task by the first network node.

In another example, that the processing unit 1020 is configured to determine the first orchestration information for the AI task includes: The processing unit 1020 is configured to determine the first orchestration information for the AI task based on an AI capability of the first network node.

In another example, the transceiver unit 1010 is further configured to receive response information from the first network node. The response information indicates whether the first network node agrees with the first orchestration information.

In another design, the apparatus 1000 is configured to perform steps or procedures performed by the network node in the embodiment shown in FIG. 3, and steps or procedures performed by the RAN in the embodiment shown in FIG. 9.

In a possible implementation, the transceiver unit 1010 is configured to receive first orchestration information from a control node. The first orchestration information indicates a first network node to execute a first task of an AI task. The processing unit 1020 is configured to execute the first task based on the first orchestration information.

In an example, that the transceiver unit 1010 is configured to receive the first orchestration information from the control node includes: The transceiver unit 1010 is configured to receive the first orchestration information and second orchestration information from the control node. The second orchestration information indicates a second network node to execute a second task of the AI task. The transceiver unit 1010 is further configured to send the second orchestration information to a second network node.

In another example, that the transceiver unit 1010 is configured to send the second orchestration information to the second network node includes: The transceiver unit 1010 is configured to send a processing result of the first task and the second orchestration information to the second network node.

In another example, the first network node is the 1st network node participating in execution of the AI task.

In another example, the first orchestration information includes at least one piece of the following information: the first task, an identifier of the first network node, a resource provided for executing the first task by the first network node, or an exit condition of executing the first task by the first network node.

In another example, the transceiver unit 1010 is further configured to send an AI capability of the first network node to the control node.

In another example, the transceiver unit 1010 is further configured to send response information to the control node. The response information indicates whether the first network node agrees with the first orchestration information.

In another example, the transceiver unit 1010 is further configured to: send the first task or a part of the first task to at least one terminal apparatus; or send the first task or a part of the first task to the second network node. The second network node is at least one network node participating in execution of the AI task.

In another example, the at least one terminal apparatus is in a preset state.

In another example, the transceiver unit 1010 is further configured to send notification information to the at least one terminal apparatus. The notification information indicates to adjust the at least one terminal apparatus to the preset state.

In another design, the apparatus 1000 is configured to perform steps or procedures performed by the first network node in the embodiment shown in FIG. 4, and steps or procedures performed by the first RAN in the embodiment shown in FIG. 6 or FIG. 8.

In a possible implementation, the transceiver unit 1010 is configured to send a processing result of a first task of an AI task and target state information to a second network node. The target state information indicates a target result of the AI task.

In an example, that the transceiver unit 1010 is configured to send the processing result of the first task of the AI task and the target state information to the second network node includes: The transceiver unit 1010 is configured to send the processing result of the first task of the AI task and the target state information to the second network node based on an AI capability of the second network node.

For another example, the transceiver unit 1010 is further configured to: send first request information to a control node or the second network node, where the first request information requests the AI capability of the second network node; and receive response information of the first request information, where the response information of the first request information indicates the AI capability of the second network node.

In another example, the transceiver unit 1010 is further configured to send second request information to the second network node. The second request information requests the second network node to cooperatively execute the AI task.

In another example, the processing result of the first task indicates current state information of the AI task.

In another example, the transceiver unit 1010 is further configured to further send area information to the second network node. The area information is used by the second network node to determine a network node that cooperatively executes the AI task.

In another example, the transceiver unit 1010 is further configured to send the first task or a part of the first task to at least one terminal apparatus.

In another example, the at least one terminal apparatus is in a preset state.

In another example, the transceiver unit 1010 is further configured to send notification information to the at least one terminal apparatus. The notification information indicates to adjust the at least one terminal apparatus to the preset state.

In another design, the apparatus 1000 is configured to perform steps or procedures performed by the second network node in the embodiment shown in FIG. 4, and steps or procedures performed by the second RAN in the embodiment shown in FIG. 6 or FIG. 8.

In a possible implementation, the transceiver unit 1010 is configured to receive a processing result of a first task of an AI task and target state information from a first network node. The target state information indicates a target result of the AI task. The processing unit 1020 is configured to execute a second task of the AI task based on the processing result of the first task and the target state information.

In an example, the transceiver unit 1010 is further configured to send an AI capability of the second network node to a control node or the first network node.

In another example, the transceiver unit 1010 is further configured to receive second request information from the first network node. The second request information requests the second network node to cooperatively execute the AI task.

In another example, the processing result of the first task indicates current state information of the AI task; and that the processing unit 1020 is configured to execute the second task of the AI task based on the processing result of the first task and the target state information includes: The processing unit 1020 is configured to execute the second task of the AI task based on the current state information of the AI task and the target state information.

In another example, the transceiver unit 1010 is further configured to receive area information from the first network node. The area information is used by the second network node to determine a network node that cooperatively executes the AI task.

In another example, the transceiver unit 1010 is further configured to send the second task or a part of the second task to at least one terminal apparatus.

In another example, the at least one terminal apparatus is in a preset state.

In another example, the transceiver unit 1010 is further configured to send notification information to the at least one terminal apparatus. The notification information indicates to adjust the at least one terminal apparatus to the preset state.

In another design, the apparatus 1000 is configured to perform steps or procedures performed by the network node in the embodiment shown in FIG. 5.

In a possible implementation, the transceiver unit 1010 is configured to send an AI task to at least one terminal apparatus. The at least one terminal apparatus is in a preset state.

In another example, the transceiver unit 1010 is further configured to send notification information to the at least one terminal apparatus. The notification information indicates to adjust the at least one terminal apparatus to the preset state.

In another design, the apparatus 1000 is configured to perform steps or procedures performed by the terminal in the embodiment shown in FIG. 5.

In a possible implementation, the transceiver unit 1010 is configured to receive an AI task from a network node. A terminal apparatus is in a preset state. The processing unit 1020 is configured to execute the AI task.

In another example, the transceiver unit 1010 is further configured to receive notification information from the network node. The notification information indicates to adjust the terminal apparatus to the preset state.

It should be understood that a specific process in which the units perform the foregoing corresponding steps is described in detail in the foregoing method embodiments. For brevity, details are not described herein.

It should be understood that the apparatus 1000 herein is embodied in a form of a functional unit. The term “unit” herein may be an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function.

For example, a product implementation form of the apparatus 1000 provided in this embodiment of the present disclosure is program code that can be run on a computer.

For example, the apparatus 1000 provided in this embodiment of the present disclosure may be a communication device, or may be a chip, a chip system (for example, a system on chip (SoC)), or a circuit used in the communication device. When the apparatus 1000 is a communication device, the transceiver unit 1010 may be a transceiver or an input/output interface, and the processing unit 1020 may be a processor. When the apparatus 1000 is a chip, a chip system, or a circuit used in the communication device, the transceiver unit 1010 may be an input/output interface, an interface circuit, an output circuit, an input circuit, a pin, a related circuit, or the like on the chip, the chip system, or the circuit; and the processing unit 1020 may be a processor, a processing circuit, a logic circuit, or the like.

In addition, the transceiver unit 1010 may alternatively be a transceiver circuit (for example, the transceiver circuit may include a receiver circuit and a transmitter circuit), and the processing unit may be a processing circuit.

In an example, FIG. 11 is a schematic block diagram of a communication apparatus 1100 according to an embodiment of the present disclosure. The apparatus 1100 includes a processor 1110, and the processor 1110 is coupled to a memory 1120. Optionally, the apparatus further includes the memory 1120, configured to store a computer program or instructions and/or data. The processor 1110 is configured to execute the computer program or the instructions stored in the memory 1120, or read the data stored in the memory 1120, to perform the methods in the foregoing method embodiments.

Optionally, there are one or more processors 1110.

Optionally, there are one or more memories 1120.

Optionally, the memory 1120 and the processor 1110 are integrated together or separately disposed.

Optionally, as shown in FIG. 11, the apparatus 1100 further includes a transceiver 1130. The transceiver 1130 is configured to receive and/or send a signal. For example, the processor 1110 is configured to control the transceiver 1130 to receive and/or send the signal.

In a solution, the apparatus 1100 is configured to implement an operation performed by a control node in the method embodiments.

For example, the processor 1110 is configured to execute the computer program or instructions stored in the memory 1120, to implement related operations performed by the control node in the foregoing method embodiments, for example, the method performed by the control node in the embodiment shown in FIG. 3, or the method performed by the AI-MF in the embodiment shown in FIG. 9.

In another solution, the apparatus 1100 is configured to implement operations performed by the network node in the foregoing method embodiments.

For example, the processor 1110 is configured to execute the computer program or instructions stored in the memory 1120, to implement related operations performed by the network node in the foregoing method embodiments, for example, the method performed by the network node in the embodiment shown in FIG. 3 and the method performed by the RAN in the embodiment shown in FIG. 9; or the method performed by the first network node in the embodiment shown in FIG. 4 and the method performed by the first RAN in the embodiments shown in FIG. 6 and FIG. 8; or the method performed by the second network node in the embodiment shown in FIG. 4 and the method performed by the second RAN in the embodiments shown in FIG. 6 and FIG. 8; or the method performed by the network node in the embodiment shown in FIG. 5.

In another solution, the apparatus 1100 is configured to implement operations performed by the terminal in the foregoing method embodiments.

For example, the processor 1110 is configured to execute the computer program or instructions stored in the memory 1120, to implement related operations performed by the network node in the foregoing method embodiments, for example, the method performed by the terminal in the embodiment shown in FIG. 5.

In an implementation process, steps in the foregoing methods may be implemented by using a hardware integrated logic circuit in the processor 1110, or by using instructions in a form of software. The methods disclosed with reference to embodiments of the present disclosure may be directly performed by a hardware processor, or may be performed by using a combination of hardware in the processor and a software module. A software module may be located in a mature storage medium in the art, such as a random access memory, a flash memory, a read-only memory, a programmable read-only memory, an electrically erasable programmable memory, or a register. The storage medium is located in the memory 1120, and the processor 1110 reads information in the memory 1120 and completes the steps of the foregoing methods in combination with hardware of the processor. To avoid repetition, details are not described herein again.

It should be understood that, in embodiments of the present disclosure, the processor may be one or more integrated circuits, and is configured to execute a related program, to perform the method embodiments of the present disclosure.

A processor (for example, the processor 1110) may include one or more processors and be implemented as a combination of computing devices. The processor may include one or more of the following: a microprocessor, a microcontroller, a digital signal processor (DSP), a digital signal processing device (DSPD), an application-specific integrated circuit (ASIC), a field programmable gate array (FPGA), a programmable logic device (PLD), gating logic, transistor logic, a discrete hardware circuit, a processing circuit, other proper hardware or firmware, and/or a combination of hardware and software, and is configured to perform various functions described in the present disclosure. The processor may be a general-purpose processor or a dedicated processor. For example, the processor 1110 may be a baseband processor or a central processing unit. The baseband processor may be configured to process a communication protocol and communication data. The central processing unit may be configured to enable the apparatus to execute a software program and process data in the software program. A part of the processor may further include a non-volatile random access memory. For example, the processor may further store information of a device type.

The program in the present disclosure represents software in a broad sense. A non-limitative example of the software includes program code, a program, a subprogram, instructions, an instruction set, code, a code segment, a software module, an application program, a software application program, or the like. The program may be run in a processor and/or a computer, to enable the apparatus to perform various functions and/or processes described in the present disclosure.

The memory (for example, the memory 1120) may store data required by the processor (for example, the processor 1110) during software execution. The memory may be implemented by using any suitable storage technology. For example, the memory may be any available storage medium that can be accessed by a processor and/or a computer. A non-limiting example of the storage medium includes a random access memory (RAM), a read-only memory (ROM), an electrically erasable programmable read-only memory (EEPROM), an optical disc read-only memory (CD-ROM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronously connected dynamic random access memory (SLDRAM), a direct memory bus random access memory (DR RAM), a removable medium, an optical disc memory, a magnetic disk storage medium, a magnetic storage device, a flash memory, a register, a state memory, a remotely installed memory, a local or remote storage component, or any other medium that can carry or store software, data, or information and that can be accessed by a processor/computer. It should be noted that the memory described in this specification aims to include but is not limited to these memories and any memory of another appropriate type.

The memory (for example, the memory 1120) and the processor (for example, the processor 1110) may be separately disposed or integrated together. The memory may be configured to connect to the processor, so that the processor can read information from the memory, and store information in and/or write information into the memory. The memory may be integrated into the processor. The memory and the processor may be disposed in an integrated circuit (where for example, the integrated circuit may be disposed in UE, a BS, or another network node).

In an example, FIG. 12 is a schematic block diagram of a chip system 1200 according to an embodiment of the present disclosure. The chip system 1200 (or may also be referred to as a processing system) includes a logic circuit 1210 and an input/output interface 1220.

The logic circuit 1210 may be a processing circuit in the chip system 1200. The logic circuit 1210 may be coupled to and connected to a storage unit, and invoke instructions in the storage unit, so that the chip system 1200 implements the methods and functions in embodiments of the present disclosure. The input/output interface 1220 may be an input/output circuit in the chip system 1200, and outputs information processed by the chip system 1200, or inputs to-be-processed data or signaling information to the chip system 1200 for processing.

In a solution, the chip system 1200 is configured to implement an operation performed by a control node in the method embodiments.

For example, the logic circuit 1210 is configured to implement a processing-related operation performed by the control node in the foregoing method embodiments, for example, a processing-related operation performed by the control node in the embodiment shown in FIG. 3, or a processing-related operation performed by the AI-MF in the embodiment shown in FIG. 9. The input/output interface 1220 is configured to implement a sending and/or receiving-related operation performed by the control node in the foregoing method embodiments, for example, a sending and/or receiving-related operation performed by the control node in the embodiment shown in FIG. 3, or a sending and/or receiving-related operation performed by the AI-MF in the embodiment shown in FIG. 9.

In another solution, the chip system 1200 is configured to implement an operation performed by a network node in the method embodiments.

For example, the logic circuit 1210 is configured to implement a processing-related operation performed by the network node in the foregoing method embodiments, for example, a processing-related operation performed by the network node in the embodiment shown in FIG. 3, or a processing-related operation performed by the RAN in the embodiment shown in FIG. 9. The input/output interface 1220 is configured to implement a sending and/or receiving-related operation performed by the network node in the foregoing method embodiments, for example, a sending and/or receiving-related operation performed by the network node in the embodiment shown in FIG. 3, or a sending and/or receiving-related operation performed by the RAN in the embodiment shown in FIG. 9.

For another example, the logic circuit 1210 is configured to implement processing-related operations performed by the network node in the foregoing method embodiments, for example, processing-related operations performed by the first network node and the second network node in the embodiment shown in FIG. 4, or processing-related operations performed by the first RAN and the second RAN in the embodiments shown in FIG. 6 and FIG. 8. The input/output interface 1220 is configured to implement sending and/or receiving-related operations performed by the network node in the foregoing method embodiments, for example, sending and/or receiving-related operations performed by the first network node and the second network node in the embodiment shown in FIG. 4, or sending and/or receiving-related operations performed by the first RAN and the second RAN in the embodiments shown in FIG. 6 and FIG. 8.

In another solution, the chip system 1200 is configured to implement an operation performed by a terminal in the method embodiments.

For example, the logic circuit 1210 is configured to implement a processing-related operation performed by the terminal in the foregoing method embodiments, for example, a processing-related operation performed by the terminal in the embodiment shown in FIG. 5. The input/output interface 1220 is configured to implement a sending and/or receiving-related operation performed by the terminal in the foregoing method embodiments, for example, a sending and/or receiving-related operation performed by the terminal in the embodiment shown in FIG. 5.

An embodiment of the present disclosure further provides a computer-readable storage medium. The computer-readable storage medium stores computer instructions used to implement a method performed by a control node, a network node, or a terminal in the foregoing method embodiments.

An embodiment of the present disclosure further provides a computer program product, including instructions. When the instructions are executed by a computer, the method performed by a control node, a network node, or a terminal in the foregoing method embodiments is implemented.

An embodiment of the present disclosure further provides a communication system. The communication system includes at least one of a control node, a network node, and a terminal in the foregoing embodiments.

For explanations and beneficial effects of related content of any one of the apparatuses provided above, refer to the corresponding method embodiments provided above. Details are not described herein again.

In the several embodiments provided in the present disclosure, it should be understood that the disclosed apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings, direct couplings, or communication connections may be implemented through some interfaces. Indirect couplings or communication connections between the apparatuses or units may be implemented in an electronic form, a mechanical form, or another form.

The units described as separate parts may or may not be physically separate, and parts displayed as units may or may not be physical units, in other words, may be located in one position, or may be distributed on a plurality of network units. Some or all of the units may be selected based on actual requirements to implement the solutions provided in the present disclosure.

In addition, functional units in embodiments of the present disclosure may be integrated into one unit, each of the units may exist alone physically, or two or more units may be integrated into one unit.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

When software is used to implement the embodiments, all or a part of the embodiments may be implemented in a form of a computer program product. The computer program product includes one or more computer instructions. When the computer program instructions are loaded and executed on the computer, the procedure or functions according to embodiments of the present disclosure are all or partially generated. The computer may be a general-purpose computer, a dedicated computer, a computer network, or other programmable apparatuses. For example, the computer may be a personal computer, a server, or a network device. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. For the computer-readable storage medium, refer to the foregoing descriptions.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. An artificial intelligence (AI) task indication method, comprising:
determining, by a control node, first orchestration information for an AI task, wherein the first orchestration information indicates a first network node to execute a first task of the AI task; and
sending, by the control node, the first orchestration information to the first network node.

2. The method according to claim 1, wherein the method further comprises:
determining, by the control node, second orchestration information for the AI task, wherein the second orchestration information indicates a second network node to execute a second task of the AI task; and
sending, by the control node, the second orchestration information to the first network node, or sending, by the control node, the second orchestration information to the second network node.

3. The method according to claim 1, wherein the method further comprises:
determining, by the control node, second orchestration information for the AI task, wherein the second orchestration information indicates a second network node to execute a second task of the AI task; and
sending, by the control node, the first orchestration information and the second orchestration information to the second network node; and
the sending, by the control node, the first orchestration information to the first network node comprises:
sending, by the control node, the first orchestration information and the second orchestration information to the first network node.

4. The method according to claim 1, wherein the first network node is the 1st network node participating in execution of the AI task.

5. The method according to claim 1, wherein
the first orchestration information comprises at least one of the following information: the first task, an identifier of the first network node, a resource provided for executing the first task by the first network node, or an exit condition of executing the first task by the first network node.

6. The method according to claim 1, wherein the determining, by a control node, first orchestration information for an AI task comprises:
determining, by the control node, the first orchestration information for the AI task based on an AI capability of the first network node.

7. The method according to claim 1, wherein the method further comprises:
receiving, by the control node, response information from the first network node, wherein the response information indicates whether the first network node agrees with the first orchestration information.

8. An artificial intelligence (AI) task indication method, comprising:
receiving, by a first network node, first orchestration information from a control node, wherein the first orchestration information indicates the first network node to execute a first task of an AI task; and
executing, by the first network node, the first task based on the first orchestration information.

9. The method according to claim 8, wherein the receiving, by a first network node, first orchestration information from a control node comprises:
receiving, by the first network node, the first orchestration information and second orchestration information from the control node, wherein the second orchestration information indicates a second network node to execute a second task of the AI task; and
the method further comprises:
sending, by the first network node, the second orchestration information to the second network node.

10. The method according to claim 9, wherein the sending, by the first network node, the second orchestration information to the second network node comprises:
sending, by the first network node, a processing result of the first task and the second orchestration information to the second network node.

11. The method according to claim 8, wherein the first network node is the 1st network node participating in execution of the AI task.

12. The method according to claim 8, wherein
the first orchestration information comprises at least one of the following information: the first task, an identifier of the first network node, a resource provided for executing the first task by the first network node, or an exit condition of executing the first task by the first network node.

13. The method according to claim 8, wherein the method further comprises:
sending, by the first network node, an AI capability of the first network node to the control node.

14. The method according to claim 8, wherein the method further comprises:
sending, by the first network node, response information to the control node, wherein the response information indicates whether the first network node agrees with the first orchestration information.

15. The method according to claim 8, wherein the method further comprises:
sending, by the first network node, the first task or a part of the first task to at least one terminal apparatus; or
sending, by the first network node, the first task or a part of the first task to the second network node, wherein the second network node is at least one network node participating in execution of the AI task.

16. The method according to claim 15, wherein the at least one terminal apparatus is in a preset state.

17. The method according to claim 16, wherein before the sending, by the first network node, the first task or a part of the first task to at least one terminal apparatus, the method further comprises:
sending, by the first network node, notification information to the at least one terminal apparatus, wherein the notification information indicates to adjust the at least one terminal apparatus to the preset state.

18. An artificial intelligence AI task indication method, comprising:
sending, by a first network node, a processing result of a first task of an AI task and target state information to a second network node, wherein the target state information indicates a target result of the AI task.

19. The method according to claim 18, wherein the sending, by a first network node, a processing result of a first task of an AI task and target state information to a second network node comprises:
sending, by the first network node, the processing result of the first task of the AI task and the target state information to the second network node based on an AI capability of the second network node.

20. The method according to claim 19, wherein the method further comprises:
sending, by the first network node, first request information to a control node or the second network node, wherein the first request information requests the AI capability of the second network node; and
receiving, by the first network node, response information of the first request information, wherein the response information of the first request information indicates the AI capability of the second network node.
